(19) United States
(12) Patent Application Publication
(10) Pub. No.: US 2016/0092091 A1
(43) Pub. Date: Mar. 31, 2016

(54) ADJUSTING PAGE LAYOUTS

(71) Applicant: Apple Inc., Cupertino, CA (US)

(72) Inventors: Eric B. Hanson, Emeryville, CA (US); Joachim Fornallaz, Cupertino, CA (US); Michael T. Turner, Cupertino, CA (US)

(21) Appl. No.: 14/868,561

(22) Filed: Sep. 29, 2015

Related U.S. Application Data
(60) Provisional application No. 62/057,606, filed on Sep. 30, 2014.

(51) Int. Cl. G06F 3/0484; G06F 17/24; G06T 11/60; G06F 3/0482

(52) U.S. Cl. CPC G06F 3/04847; G06F 3/0482; G06F 3/04842; G06F 17/248; G06T 11/60; G06T 2200/24

(57) ABSTRACT

A group of files are presented on a graphical user interface using a template. The presentation is controlled by a rule associated with the template. A user input for adjusting a layout parameter of a selected file of the group of files is received. In response, the rule is examined and the layout parameter of the selected file is adjusted based on the rule. One or more next files in the group of files are evaluated to determine if the rule is satisfied following adjusting the layout parameter of the selected file. Based on determining that the rule is violated, layout parameters of the one or more next files are recursively adjusted until the rule is satisfied. The presentation of the group of files using the template is updated based on recursively adjusting the layout parameters of the one or more next files.

### CROSS-REFERENCE TO RELATED APPLICATION

This application claims priority to U.S. Provisional Patent Application No. 62/057,606, entitled “ADJUSTING PAGE LAYOUTS,” filed Sep. 30, 2014, the entire contents of which are incorporated herein by reference.

### TECHNICAL FIELD

This disclosure relates generally to adjusting page layouts corresponding to arrangement of digital files on a display.

### BACKGROUND

A user may view graphical representations, for example thumbnails, of digital files on a device display. The user can move or resize the thumbnails to change the displayed arrangement.

### SUMMARY

Techniques are described for automatically adjusting page layouts associated with arrangement of digital files on a display. In a general aspect, a group of first files are presented on a graphical user interface shown on a device display using a first template. The presentation of the group of first files on the graphical user interface using the first template is controlled by a first rule associated with the first template. A first user input for adjusting a layout parameter of a selected file of the group of first files is received through an input interface. In response to receiving the first user input, the first rule associated with the first template is examined, where the first rule constrains adjustment of the layout parameter of the selected file. The layout parameter of the selected file is adjusted based on the first rule.

One or more next files in the group of first files are evaluated to determine if the first rule is satisfied following adjusting the layout parameter of the selected file. Based on determining that the first rule is violated following adjusting the layout parameter of the selected file, layout parameters of the one or more next files are recursively adjusted until the first rule is satisfied. The presentation of the group of first files using the first template is updated based on recursively adjusting the layout parameters of the one or more next files.

Particular implementations may include one or more of the following features. A second user input may be received for adding one or more new files to the group of first files for presentation on the graphical user interface. In response to receiving the second user input, the one or more new files may be added to the group of first files. For each file included the one or more new files, the first template may be adjusted by performing the evaluating of a next file.

A group of second files may be presented on the graphical user interface using a second template. Presentation of the group of second files using the second template may be controlled by a second rule associated with the second template. The group of second files may be presented in conjunction with presenting the group of first files using the first template. A second user input may be received, through the input interface, for adjusting a layout parameter of a selected file of the group of second files. In response to receiving the second user input, the layout parameter of the selected file of the group of second files may be adjusted based on the second rule. One or more next files in the group of second files may be evaluated to determine if the second rule is satisfied following adjusting the layout parameter of the selected file of the group of second files. Based on determining that the second rule is violated, layout parameters of the one or more next files in the group of second files may be recursively adjusted until the second rule is satisfied. The presentation of the group of second files using the second template may be updated based on recursively adjusting the layout parameters of the one or more next files in the group of second files.

Recursively adjusting the layout parameters of the one or more next files in the group of second files may comprise recursively adjusting the layout parameters of the one or more next files in the group of second files without adjusting layout parameters of the group of first files. Updating the presentation of the group of second files using the second template may comprise updating the presentation of the group of second files using the second template without updating the presentation of the group of first files.

Presenting the group of first files on the graphical user interface using the first template may comprise determining a content type of the first files, and selecting the first template based on the content type of the first files. A second user input may be received for adding a new file for presentation on the graphical user interface. In response to receiving the second user input, a content type of the new file may be determined. The content type of the new file may be determined to be different from the content type of the first files. Based on determining that the content type of the new file is different from the content type of the first files, a second template may be selected from device storage for presenting the new file on the graphical user interface, where the second template may be associated with the content type of the new file. The new file may be presented on the graphical user interface using the second template. Presenting the new file on the graphical user interface using the second template may be controlled by a second rule associated with the second template.

A next file in the group of first files may include a file that is adjacent to the selected file. Evaluating the one or more next files in the group of first files may comprise identifying one or more files that are adjacent to the selected file. The one or more adjacent files may be evaluated to determine if the first rule is satisfied following adjusting the layout parameter of the selected file. Based on determining that the first rule is violated following adjusting the layout parameter of the selected file, layout parameters of the one or more adjacent files may be recursively adjusted. One or more additional files in vicinity of the one or more adjacent files may be identified. The one or more additional files may be evaluated to determine if the first rule is satisfied following adjusting layout parameters of the one or more adjacent files. Based on determining that the first rule is violated following adjusting the layout parameters of the one or more adjacent files, layout parameters of the one or more additional files may be recursively adjusted until the first rule is satisfied. The presentation of the group of first files using the first template may be updated based on adjusting the layout parameters of the one or more files and the one or more additional files.

The first rule may include sub-rules. The sub-rules may be arranged in a precedence order. In response to receiving the first user input, the layout parameter of the selected file may be adjusted based on examining the sub-rules in the precedence order. Based on determining that one or more sub-rules are violated following adjusting the layout parameter of the selected file, layout parameters of the one or more next files may be recursively adjusted until a first sub-rule is satisfied. The first sub-rule may head the one or more violated sub-rules in the precedence order. Following satisfying the first sub-rule, layout parameters of the one or more next files may be recursively adjusted until a second sub-rule is satisfied. The second sub-rule may be after the first sub-rule in the precedence order.

The files included in the group of first files may be associated with different content types. The first template may be associated with a grid layout for arranging the group of first files on the graphical user interface. The grid layout may include one or more of a center alignment grid, a no-overlap grid, or a no-gap grid. The grid layout may include multiple grids. Different grids may correspond to different content types associated with files.

Implementations of the above techniques include methods, systems, computer program products and computer-readable media. One such computer program product is suitably embodied in a non-transitory storage medium that stores instructions executable by one or more processors. The instructions are configured to cause the one or more processors to perform the above-described actions. One such system includes one or more processors and instructions stored in a storage medium. The instructions, when executed by the one or more processors, are configured to cause the one or more processors to perform the above described actions.

The features described in this specification can be implemented to achieve one or more advantages. For example, graphical representations of files may be automatically arranged in the graphical user interface based on a predetermined thematic design intention, which may be that the arrangement of the graphical representations is suitable for printing, e.g., as a photo collage or album, calendar, greeting card, etc. The design intention may be specified by one or more rules associated with the underlying page layout on which the graphical user interface is based. A user may customize the arrangement of the graphical representations to suit the user's own preferences. The device may accommodate the user's customizations while maintaining the overall design intention of the arrangement specified by the page layout by automatically updating the graphical representations such that changes made based on the user input satisfy the rules associated with the page layout.

The details of one or more implementations are set forth in the accompanying drawings and the description below. Other features, aspects, and advantages will become apparent from the description, the drawings, and the claims.

### BRIEF DESCRIPTION OF THE DRAWINGS

FIGS. 1A and 1B present exemplary views of a device that may be used for automatically adjusting page layouts for displaying digital files.

FIGS. 2A, 2B, 2C and 2D present examples of page layouts that may be used for displaying an arrangement of files in a GUI.

FIGS. 3A, 3B and 3C illustrate examples of user inputs for adjusting graphical representations of files in a GUI.

FIGS. 4A-4E are flowcharts illustrating exemplary processes for automatically adjusting page layouts for file arrangements.

FIG. 5 is a block diagram illustrating exemplary device architecture of an electronic device implementing the features and operations of FIGS. 1A-1B, 2A-2D, 3A-3C and 4A-4E.

FIG. 6 is a block diagram of exemplary network operating environment for the electronic devices implementing the features and operations of FIGS. 1A-1B, 2A-2D, 3A-3C, 4A-4E and 5.

FIG. 7 is a block diagram of exemplary system architecture for implementing the features and operations of FIGS. 1A-1B, 2A-2D, 3A-3C, 4A-4E, 5 and 6.

Like reference symbols in the various drawings indicate like elements.

### DETAILED DESCRIPTION

### Exemplary Device for Adjusting Page Layouts for File Arrangements

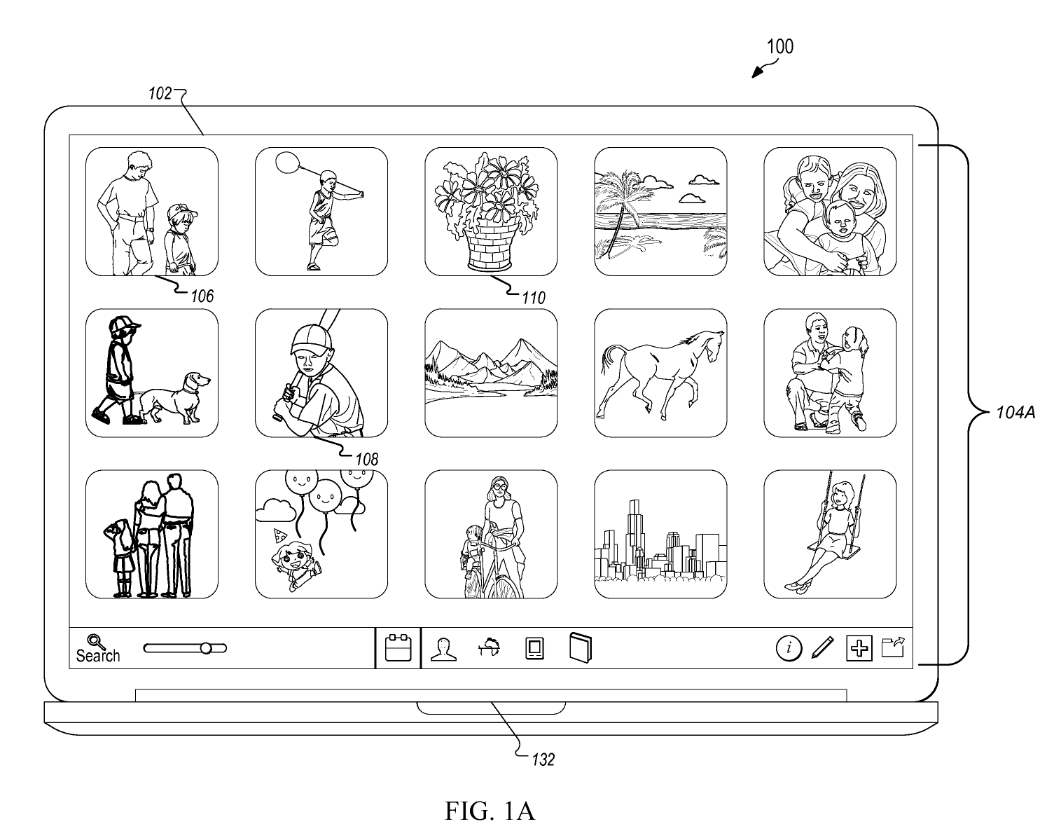

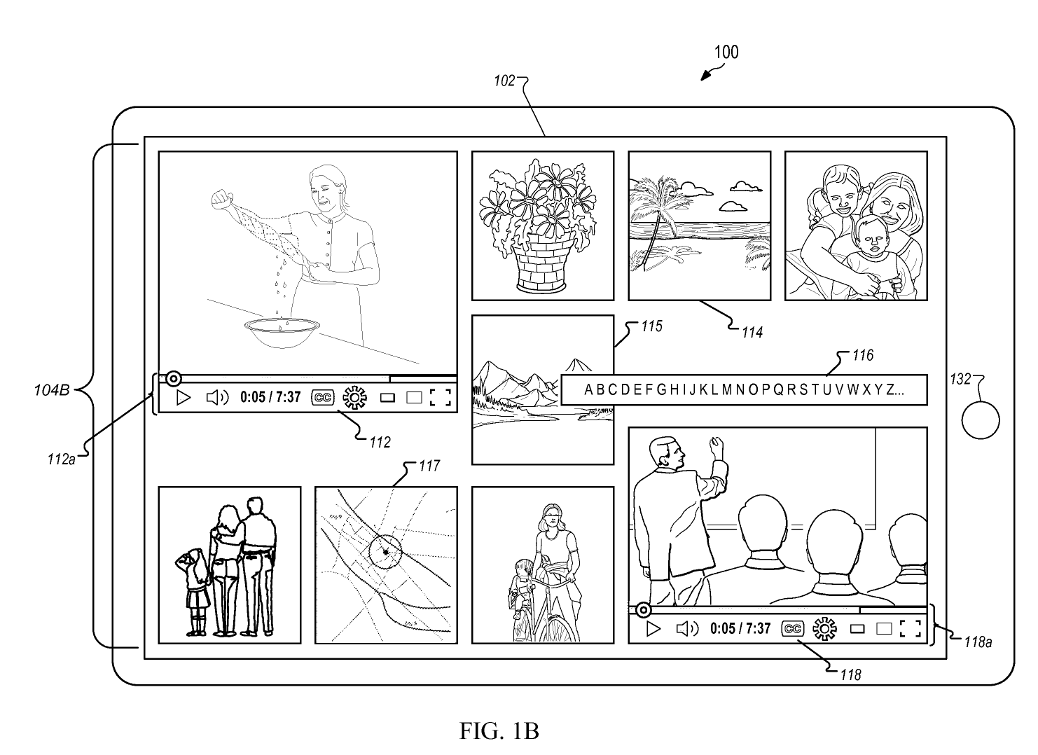

FIGS. 1A and 1B present exemplary views of a device 100 that may be used for automatically adjusting page layouts for displaying digital files. For example, the device 100 is configured to display graphical representations, such as thumbnails, of different types of digital files (also referred to simply as files), e.g., image files, video files, audio files, text files, map frames, or some other suitable type, using a graphical user interface (GUI) shown on the device display. The graphical representations may be presented on the display in an arrangement that is based on a page display layout. The device may receive one or more inputs from a user, who is operating the device, to change the position of one or more displayed files, and/or resize one or more displayed files, in the arrangement. Based on receiving the user inputs, the device 100 may automatically adjust the page display layout such that the updated arrangement of the graphical representations of the files in the GUI conforms to some rules associated with the page display layout.

In this context, a page refers to a portion of the GUI that is shown on a device display at a time. A page display layout, which is also referred to interchangeably as a page layout, print product layout, or grid layout, refers to an arrangement of files, or graphical representations thereof, in the GUI shown on the device display. The position of each file representation in the GUI may correspond to the position of the file in the underlying page layout. Each page layout is associated with rules that determine how the files are ordered in the page layout (and accordingly, how the files are displayed in the GUI), how the files are arranged relative to one another and relative to the overall page layout, or other suitable configuration parameters associated with presenting files for display in the GUI. In some implementations, a page layout includes one or more grid layouts (also referred to as grids) in which the files are arranged. The rules associated with the page layout may correspond to rules associated with the included grid layouts.

Adjusting a page layout refers to updating the positions of the files in the page layout in a manner that conforms to the rules associated with the page layout, as described in greater detail in the following sections. The operation of adjusting the page layout may be performed by the device hardware (e.g., processing circuitry, programmable hardware elements, ASICs, etc.) or software executed by the device (e.g., application software or operating system software that is configured to present the file arrangement on the device display, etc.). In some implementations, the device or the software executed by the device that adjusts the page layout may be same as the entity that is configured to present the GUI. However, in other implementations, adjusting the page layout and presenting the GUI may be performed by separate entities (e.g., different software modules). In the following sections, the term device is used to refer to both the device hardware and the above-mentioned software executed by device.

In this context, automatically adjusting refers to an action or operation performed by the device without user input directly specifying or performing the action or operation. Accordingly, the term “automatically” is in contrast to an operation being manually performed or specified by the user, where the user directly provides input to perform the operation. In some implementations, the automatic adjustment of a page layout may be initiated by input provided by the user, but the subsequent actions that are performed automatically are not specified by the user, i.e., are not performed manually, where the user specifies each action to perform. For example, the user providing input to change the position of a file in the arrangement shown in the GUI is selecting the file manually, even though the device may process the file (e.g., visually move the graphical representation of the file) in response to the user action. The device may automatically check whether the user-specified position change of the file satisfies the rules governing the page layout. Additionally or alternatively, when the device updates the position of the user-selected file, the device may automatically update positions of other files in the displayed arrangement, without any user input specifying the positions of the other files, such that the associated page layout rules are satisfied. The following sections provide various examples of operations being automatically performed in response to actions the user has taken.

As shown in FIG. 1A, the device 100 includes a display 102. A graphical user interface (GUI) 104A may be shown on the display 102. One or more graphical representations of digital files (also referred to as files) 106, 108 and 110 may be shown in the GUI 104A.

FIG. 1B shows another example of the device 100, which includes a different GUI 104B shown on the display 102. The GUI 104B also may include one or more of the graphical representations of files 110, 112, 114, 115, 116, 117 and 118.

The device 100, which is also referred to interchangeably as a user device or client device, is an electronic device. In some implementations, the device 100 may be a mobile device, for example, a smartphone; an electronic tablet; a portable music player; an electronic book reader; a wearable device including, for example, a smart watch, smart eyeglasses or a fitness tracker; a regular cellular phone; or a laptop computer, among others. For example, the device 100 shown in FIG. 1A may represent a laptop, while the device 100 shown in FIG. 1B may represent a smartphone or an electronic tablet. In some implementations, the device 100 may be a desktop computer.

The device 100 includes one or more input interfaces that allow the user to provide input. In some implementations, the device 100 includes input interface 132, which may be, for example, a keyboard or a touchpad (as shown in FIG. 1A), or an electronic thumb button input (as shown in FIG. 1B). The input interface 132 also may be a mouse, track wheel, rotary dial or crown, or some other suitable input interface.

In some implementations, the device 100 includes a touch interface for enabling user input. For example, the display 102 may include a touch-sensitive surface. The user may provide input by touching the touch-sensitive surface using, for example, one or more fingers, or a stylus or digital pen, or some other suitable mechanism. The structure and components of the device 100 are described in the following sections with respect to the exemplary device architecture 500, the exemplary network operating environment 600 and the exemplary system architecture 700.

As described above, the GUI 104A or the GUI 104B may be presented on the display 102 by software executed by the device 100. In some implementations, the software may be operating system software running on the device 100 that is configured to present the GUI 104A or 104B. For example, the operating system software may be Apple iOS™, Apple OS X™, or some other suitable operating system software. In some implementations, the software may be application software that is executed by the device 100. The application software may be executed in addition, or as an alternative, to the operating system software. For example, the application software may be image and/or video processing software such as Apple iPhoto™, Apple Aperture™, Apple iMovie™, Apple OS X Photos application, Apple iOS Photos application, Apple iOS Video application, or some other suitable image and/or video processing software. Alternatively, the application software may be a text and/or document processing software such as Apple iOS Notes application, OS X Notes, Apple Pages™, Apple Keynote™, Apple Numbers™, or some other suitable text/document processing software.

As shown in FIGS. 1A and 1B, one or more graphical representations (for example, thumbnails) of files 106, 108, 110, 112, 114, 115, 116, 117 and 118 may be shown in the GUI 104A or 104B. In some implementations, the graphical representations correspond to image files, such as photos. For example, 106, 108, 110, 114 and 115 may correspond to image files and the associated graphical representations may represent thumbnails of the image files.

In some implementations, the graphical representations may correspond to video files. For example, the graphical representations 112 and 118 may represent video files, and 108 may be thumbnails of images from frames in the corresponding video files. In some implementations, the graphical representations of video files may include controls 112a or 118a for previewing/playing the video files.

In some implementations, the graphical representations may correspond to text files (e.g., documents). For example, graphical representation 116 may correspond to a text file and may be a thumbnail showing text from the document. Alternatively, the graphical representation 116 may represent entirety of a text file. For example, it may be a text caption, title, etc. In some implementations, a graphical representation may correspond to a mix of files of different types, such as one or more of images, videos and text, or some other suitable file type.

In some implementations, the graphical representations may correspond to map frames. For example, graphical representation 117 may correspond to a geographic map file.

As shown by the GUI 104A and 104B, the graphical representations may be shown in the GUI in a particular arrangement. For example, the graphical representations of the files 106, 108, 110, etc. may be presented in the GUI 104A in a two-dimensional array arrangement. Similarly, the graphical representations of the files 112, 114, 115, 116, 118, etc. may be presented in the GUI 104B in a different arrangement. Each arrangement of files in the GUI 104A or 104B may be based on an underlying page layout used by the device for determining how the file representations are shown in the GUI.

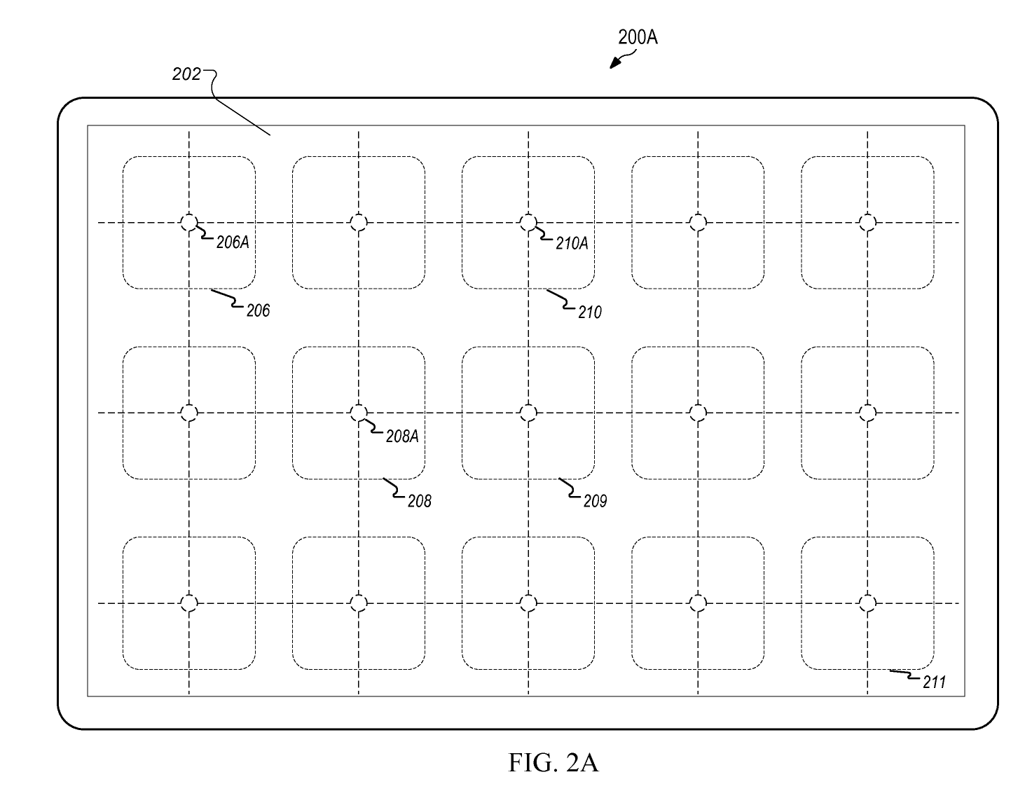

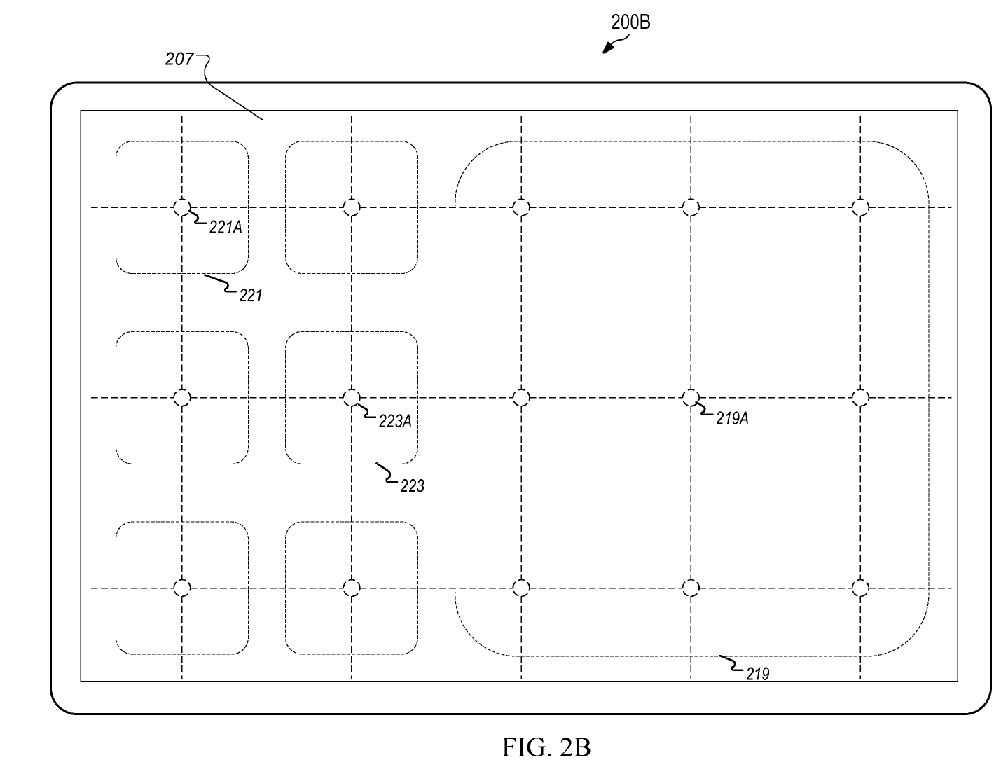

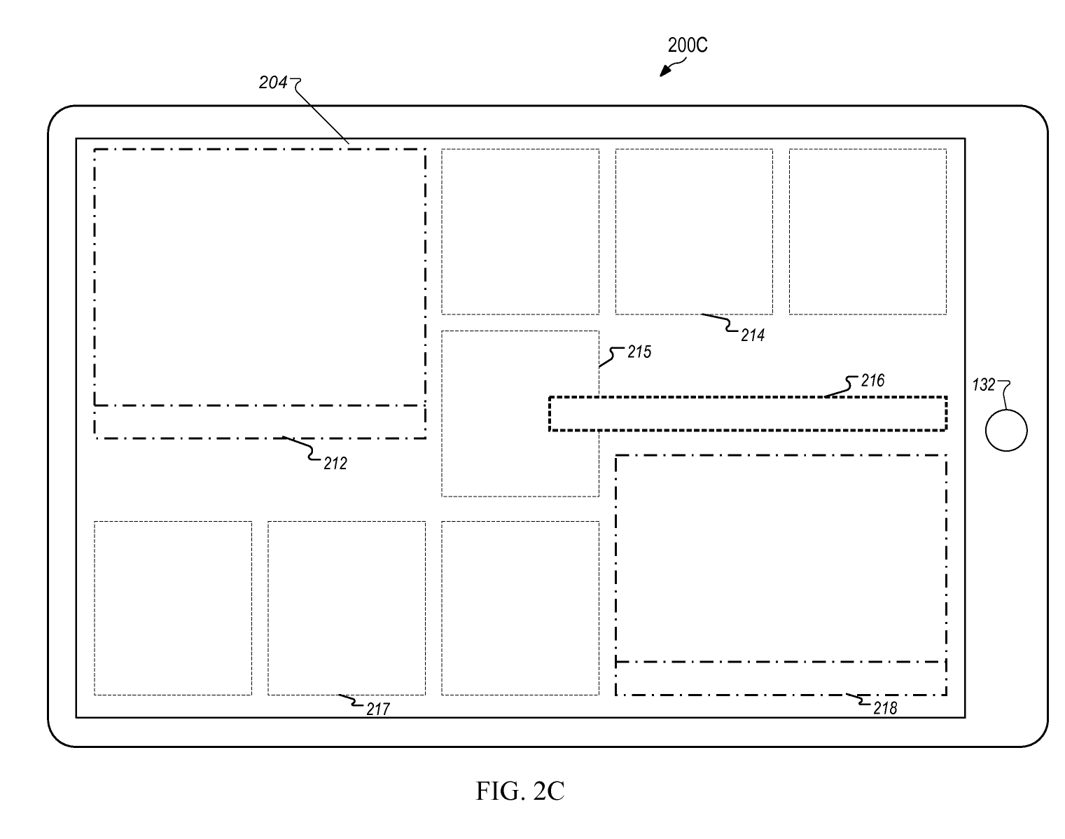

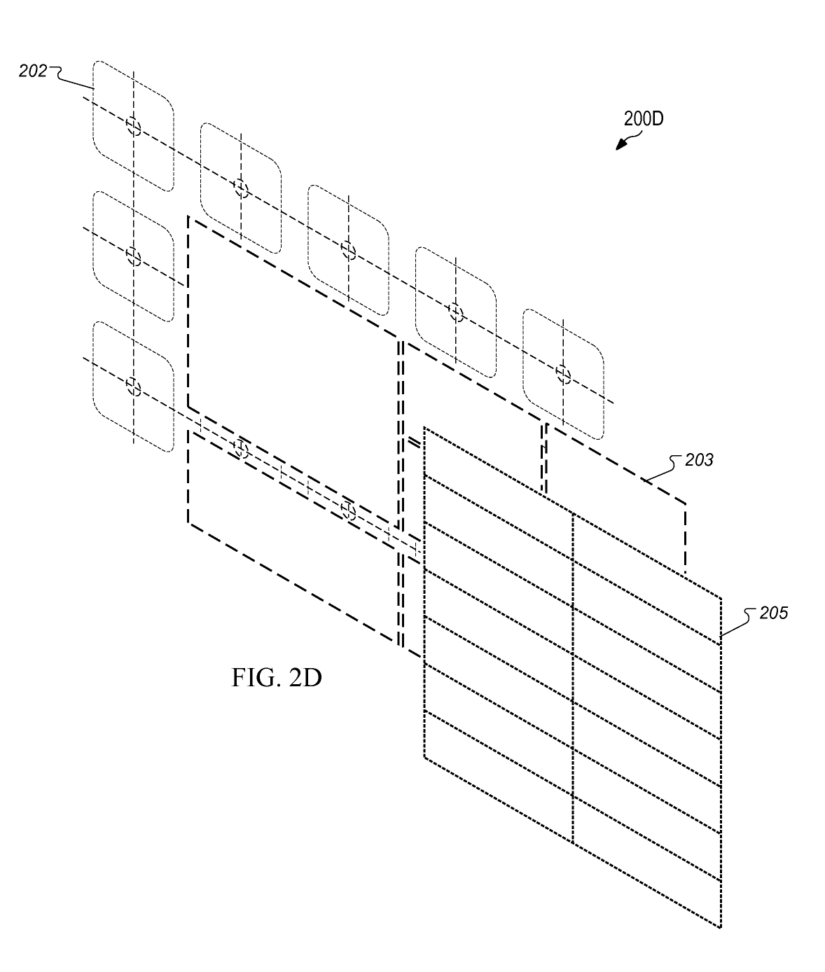

FIGS. 2A, 2B, 2C and 2D present examples of page layouts 200A, 200B, 200C and 200D that may be used for displaying an arrangement of files in a GUI. One or more of the page layouts 200A, 200B, 200C or 200D may correspond to the arrangement of the file graphical representations in the GUI 104A or 104B or both. For example, the graphical representations 106, 108, 110, etc. may be arranged in the GUI 104A based on the page layout 200A in FIG. 2A.

In some implementations, a page layout may include one or more grids or grid layouts corresponding to the arrangement of files. For example, the page layout 200A may include a grid 202; page layout 200B may include a grid 207; page layout 200C may include a grid 204; and page layout 200D may include grids 202, 203 and 205. In some implementations, the terms page layout and grid layout may be used synonymously, e.g., when a page layout includes a single grid layout, such as the page layout 200A including the grid layout 202.

As noted previously, each page layout may be based on a certain thematic design intention for the arrangement of graphical representations in the GUI. For example, one theme or design intention may be to arrange the graphical representations in a manner that is suitable for a calendar display; another theme or design intention may correspond to a photo collage display; yet another design intention may correspond to a scrapbook theme.

For each design intention, there may be a predetermined set of rules that govern the associated page layout, i.e., one or more grids in the page layout. In some implementations, a rule associated with a grid layout may specify the positions of frames or elements in the grid, where a frame in the grid is associated with a graphical representation in the GUI. For example, the positions of the graphical representations 106, 108 and 110 in the GUI 104A may correspond to the elements (also referred to as frames) 206, 208 and 210 that are specified in the grid 202, and similarly other graphical representations in the GUI 104A may correspond to other specified elements or frames (e.g. 211) in the grid layout 202.

In some implementations, when the user provides an input (e.g., using a suitable input interface or touch interface described above) to add the graphical representation of a file to the GUI 104A, the predetermined rules governing the page layout 200A (i.e., rules associated with the grid layout 202) may automatically position the file in one of the frames specified in the page layout. For example, the frame 211 may be empty, i.e., not associated with an existing file graphical representation, and the page layout rules may position the graphical representation associated with the newly-added file in the frame 211. Additionally or alternatively, a rule may specify the desired proximity of frames in the grid to each other, whether the frames are allowed to rotate, degree of rotation of the frames, or some other suitable design parameter.

In some implementations, the grid 207 shown in the page layout 200B is similar to the grid 202, and follows similar rules for positioning graphical representation associated with the newly-added files in available frames. However, the page layout 200A may allow addition of graphical representations in similarly sized frames, while the page layout 200B may allow addition of graphical representations in frames of different sizes. For example, the frames 206, 208, 209, 210 and 211 in the grid 202 may be of the same size. In contrast, frame 219 in grid 207 may be of a different size than frames 221 or 223 in grid 207. The frame 219 may be a multiple of the size of the frame 221 or 223. In some implementations, frames 221 and/or 223 may be similar to one or more of the frames 206, 208, 209, 210 and 211.

In a manner similar to that described with respect to the GUI 104A and the page layout 200A, the graphical representations 112, 114, 115, 116, 117, 118, etc. may be arranged in the GUI 104B based on the grid 204 included in the page layout 200C shown in FIG. 2C. For example, the positions of the graphical representations 112, 114, 115, 116, 117 and 118 in the GUI 104B may correspond to the frames 212, 214, 215, 216, 217 and 218 that are specified in the grid layout 204, and similarly other graphical representations in the GUI 104B may correspond to other frames in the grid layout 204.

In some implementations, the page layout, or the grids included in a page layout, may be not be visible in the GUI. For example, the page layout 200A, the page layout 200B or the page layout 200C may not be visible on the device display. Accordingly, the grid 202 including frames 206, 208, 210 and 211, the grid 207 including the frames 219, 221 and 223, or the grid 204 including frames 212, 214, 215, 216, 217 and 218 may not be shown on the device display. The page layout 200A, 200B or 200C may be an internal structure or configuration used by the device to arrange the graphical representations for presentation in one or more pages of the GUI 104A or 104B that are shown on the device display.

As noted above and described in the following sections, the predetermined rules associated with the grid(s) in the page layout may govern the displayed arrangement of the graphical representations in the GUI. In some implementations, the rules for a page layout may be configured as part of designing the page layout, e.g., by a developer who programs the page layout, or the software (either application software or operating system software) that provides the page layouts for displaying graphical representations in the GUI. In some other implementations, the rules for a page layout may be configured by a user.

A user may customize the arrangement of the graphical representations to suit the user's own preferences, and thereby modify the predetermined page layout. The device may accommodate the user's customizations while maintaining the overall design intention of the arrangement specified by the page layout by automatically updating frames in the page layout such that changes made based on the user input satisfy the rules associated with the page layout.

In some implementations, a page layout may be symmetrical or asymmetrical. For example, the grid 202 in the page layout 200A may be a symmetrical grid in which all the specified frames are evenly-spaced. Correspondingly, the graphical representations 106, 108, 110, etc., in the GUI 104A, when based on the page layout 200A, may be uniformly spaced as shown. In contrast, the grid 204 in page layout 200C may be an asymmetrical grid layout in which the specified frames may not be evenly-spaced. Correspondingly, the graphical representations 112, 114, 115, 116, 118, etc., in the GUI 104B, when based on the page layout 200C, may be less-uniformly, or irregularly, spaced as shown.

In some implementations, the device may use the same grid layout for files of different types. For example, the device 100 may use the grid layout 204 to arrange representations of video files (e.g., 212), representations of image files (e.g., 214), representations of map frames (e.g., 217), and/or representations of text files (e.g., 216) in the GUI 104B. In such implementations, when the user provides an input to add a new graphical representation to a page in the GUI, the device may add the graphical representation to the GUI based on the existing grid layout used for the GUI, irrespective of the content type associated with the file being added.

However, in some implementations, the device may use different grid layouts for files of different types. For example, the device may use page layout 200D, shown in FIG. 2D, to arrange graphical representations in a GUI based on the content types of the files being represented. The page layout 200D includes multiple grid layouts 202, 203 and 205. For example, the graphical representations 112, 114, 115, 116, 117, 118, etc. may be arranged in the GUI 104B based on one or more of the grid layouts 202, 203 and/or 205 that are used simultaneously by the device to arrange the graphical representations in the GUI 104B. The device may arrange representations of image files in the frames of the grid layout 202; the device may arrange representations of video files and/or map frames using the grid layout 203; and the device may arrange representations of text files in the frames of the grid layout 205.

In some implementations, different grids in a page layout may follow different grid rules. For example, rules associated with the different grids may align the frames in their respective grids in different ways. Considering the page layout 200D, the frames in the grid 202 may be equally-sized and/or aligned in a symmetric manner; the frames in grid 203 may be arbitrarily-shaped and/or aligned asymmetrically; and frames in the grid 205 may be aligned such that there is no gap between the frames, in contrast to the grids 202 and 203.

In some implementations, different grids in a page layout may be in different physical planes such that the GUI arrangement of graphical representations based on the grids of the page layout may appear to have a three-dimensional effect. In some implementations, when a file representation is added to a grid in a page layout, the grid may be transformed such that the grid is in a different plane relative to other grids in the page layout, providing the three-dimensional effect.

In implementations that use different grid layouts for files of different types, when a user provides an input to add a new graphical representation to a page in the GUI, the device may check the content type associated with the file being added, and accordingly select a grid layout that is suitable for this content type. For example, in the scenario described above, the user may provide an input to add a new photograph to the GUI 104B. Upon processing the user input, the device determines that the file being added to the GUI has content type image. Accordingly, the device selects the grid layout 202 that is used for image files, and positions the graphical representation of the newly-added file in a frame of the grid layout 202, following the rules governing the grid layout 202. However, if the device determines that the file being added to the GUI has content type text, then the device selects the grid layout 205 that is used for text files, and positions the graphical representation of the newly-added file in a frame of the grid layout 205, following the rules governing the grid layout 205. In this manner, rules associated with a page layout may be used to implement an intelligent grid system in which file representations are automatically arranged based on the associated content types.

When multiple grid layouts are used to arrange graphical representations in a GUI as described above, the different grid layouts may overlap on each other. For example, the graphical representation of a text file, which may be arranged using the grid layout 205, may overlap on graphical representations of image files and/or video files, which may be arranged using the grid layouts 202 and 203 respectively. Accordingly, the graphical representation of text file 116 may overlap on the graphical representation of image file 115, as shown in the GUI 104B.

In some implementations, when multiple grid layouts are used, the device 100 may process the rules associated with the different grid layouts separately. For example, when adding or adjusting image files in the GUI 104B, the device may adjust only the grid layout 202 that is used for image files, without affecting the grid layouts 203 or 205 that are used for files of other types. Adjustment may be limited to the grid layout that is used for the content type of the file being added/modified in situations where the rules for the different grid layouts can be satisfied independent of one another. This may be the case, for example, when the arrangement of file representations of one type in the GUI may be made independent of the arrangements) of file representations of other type(s) that may be concurrently present in the GUI.

In some other implementations, the device may process the rules associated with the different grid layouts together. In such implementations, adjustment to a grid layout may trigger adjustments to other grid layouts that are used concurrently for presenting items in the GUI. For example, when adding or adjusting an image file in the GUI 104B, the device may adjust not only the grid layout 202 used for image files, but also the grid layouts 203 and/or 205, which are used for files of the types. The adjustment to the different grid layouts for the different files types may be made such that the rules governing the grid layouts are satisfied in the event of a change to any one grid layout. This may be the case, for example, when the arrangement of file representations of one content type in the GUI may impact the arrangements) of file representations of other content type(s) that may be concurrently present in the GUI. The following sections describe how the device processes the rules governing page layouts and grid layouts when the device receives a user input for adjusting a graphical representation in the GUI.

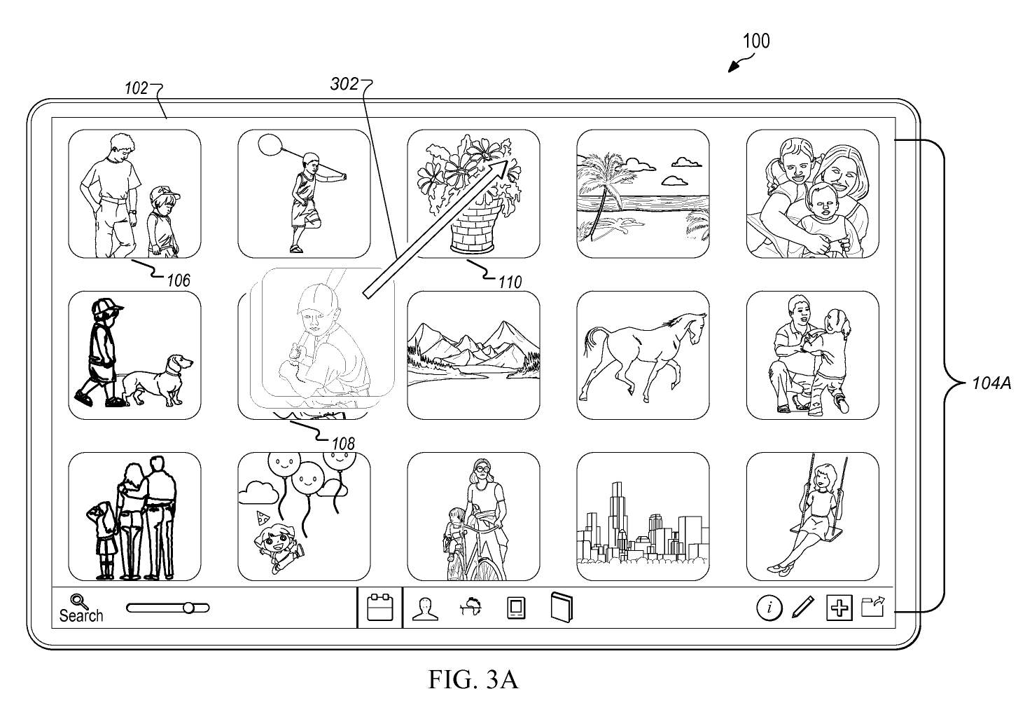

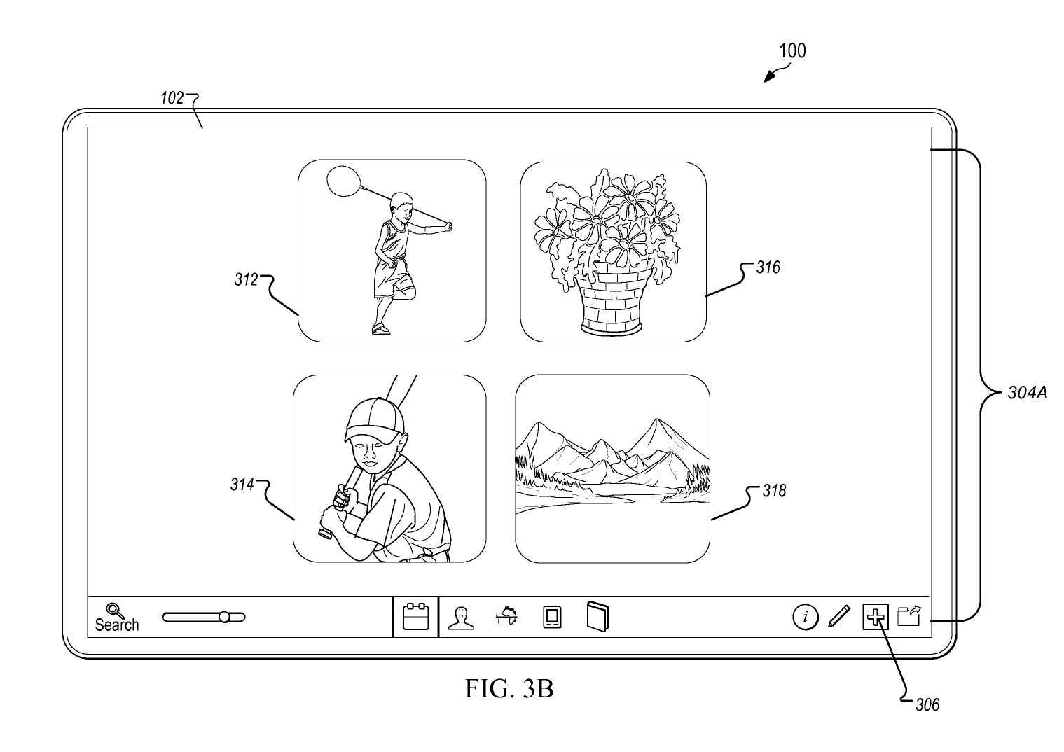

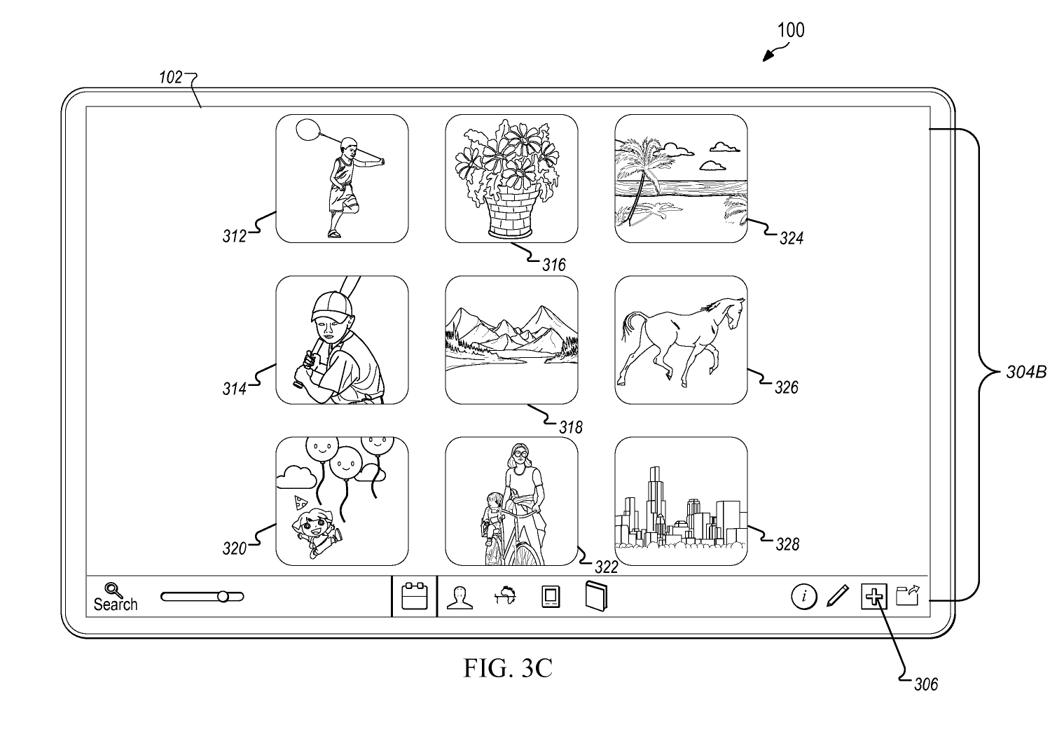

FIGS. 3A, 3B and 3C illustrate examples of user inputs 302, 306, for adjusting graphical representations of files in a GUI. FIG. 3A shows an arrangement of graphical representations in a GUI where a user input is received to move one or more graphical representations. In some implementations, the GUI shown in FIG. 3A may be similar to the GUI 104A. However, in other implementations the GUI shown in FIG. 3A may be some other suitable GUI that is presented on the display 102 of the device 100 (e.g., similar to GUI 104B).

Referring to GUI 104A, the user may provide input 302 to move the graphical representation 108 to a position in the GUI that is occupied by graphical representation 110. The user may provide a similar input to adjust a graphical representation in the GUI 104B. In some implementations, the user input 302 may correspond to a different adjustment, e.g., moving the graphical representation 108 to a different position in the GUI, changing the size of the graphical representation 108, adding a new graphical representation to the GUI, removing a graphical representation from the GUI, or some other suitable adjustment to a graphical representation shown in the GUI.

In some implementations, in response to receiving the user input, the device processes the rules governing the underlying page layout to automatically adjust the positions of the graphical representations in the GUI. For example, when the user provides input 302 to move the graphical representation 108 to a position in the GUI 104A that is occupied by graphical representation 110, the device 100 may process the rules governing the page layout that corresponds to the GUI 104A, e.g., page layout 200A. Based on the user input 302, the device may attempt to move the frame 208 corresponding to the graphical representation 108 to the position of the frame 210 in the grid layout 202 that is included in the page layout 200A. The rules governing the grid layout 202 may specify that two frames cannot overlap in the grid. Accordingly, the device may move the frame 210 to a different position in the grid 202 to enable the frame 208 to move to the space previously occupied by the frame 210. The frame 210 may be moved to a different position in a manner that satisfies the rules of the grid layout 202. In moving the frame 210, the device may adjust positions of other frames as well to satisfy the grid layout rules. The device 100 may evaluate remaining graphical representations in the GUI 104A against the applicable page layout to determine if they need to be adjusted automatically to maintain the design intention, i.e., the rules associated with the page layout.

The above adjustments may be performed in a recursive manner. For example, when moving the frame 208 based on the user input, the device may first evaluate one or more frames that are adjacent to the frame 208 (e.g., 210) and adjust these frames such that the rules associated with the page layout are satisfied. Then the device may further evaluate additional frames that are next to these adjusted frames adjacent to 208, and adjust these additional frames as needed to satisfy the page layout rules. Subsequently the device may evaluate and adjust other frames that are adjacent to these additional frames, and so on. The adjustment process may continue until the page layout rules are satisfied for all the frames in the layout.

In some implementations, the recursive adjustments may be performed by evaluating not just the adjacent frames at a time, but instead one or more frames that are within a certain vicinity of the frames that have been adjusted. For example, all frames that are within N number of frames (where N is an integer, e.g., N=2 or 3) proximity to an adjusted frame may be evaluated at a time. In some implementations, the vicinity within which frames are evaluated and adjusted as needed may be a parameter that is preconfigured in the device.

FIG. 3B shows an arrangement of graphical representations in a GUI 304A where a user input is received to add one or more new graphical representations. The GUI 304A may present graphical representations of files 312, 314, 316 and 318 that are arranged with certain dimensions and in certain positions based on an underlying page layout that governs the GUI 304A display. The user may provide an input 306 (for example, by selecting the “+” or add option displayed in the GUI 304A) to add one or more new graphical representations to the arrangement shown in GUI 304A.

In response to receiving the user input 306, the device 100 may process one or more rules associated with a grid in the underlying page layout to add a frame or frames in the grid corresponding to the new file or files being added. By processing the rules, the device may automatically resize the dimensions of the existing frames, and/or automatically reposition the existing frames, to make space for each newly-added frame in the grid.

As described above, the automatic resizing and/or repositioning may be performed recursively. For example, an existing frame may be resized and/or repositioned and then one or more frames that are next to (i.e., adjacent to or within a certain vicinity of) the adjusted frame may be evaluated to determine if the grid rules are violated. If a determination is made that the grid rules are violated, then these one or more frames may be resized and/or repositioned. Subsequently, other frames that are next to these one or more frames may be evaluated and adjusted as needed. The adjustment process may continue until the page layout rules are satisfied for all frames in the layout, including the existing frames and the newly-added frame.

In some implementations, resizing and/or repositioning existing frames in the grid may be performed in a manner such that a suitable arrangement that is consistent with the overall thematic design of the page layout is achieved, while satisfying the grid rules. For example, the existing frames may be resized to make space for the newly-added frame(s) within the constrained area of the page layout. The resized dimensions of the existing frames and the dimension of the newly-added frame(s) may be consistent with one another. Additionally or alternatively, the existing frames may be repositioned to make space for the newly-added frame(s) within the constrained area of the page layout. The relative positions of the existing frames and the newly-added frame(s) may follow the positioning rules of the grid, e.g., they may be symmetrically (or asymmetrically, depending on the grid rule) placed with respect to each other.

In the above manner, for each new file that is added to the GUI 304A by the user, the device 100 may automatically adjust existing frames in the underlying grid to accommodate a frame for the new file. In some implementations, the user may add multiple files simultaneously, e.g., by selecting a folder and adding all the files from the folder. The device 100 will recursively perform the automatic adjustments to the existing frames to add a frame corresponding to each new file. The automatic adjustments will terminate when frames corresponding to all the new files have been added to the grid, consistent with the grid rules.

FIG. 3C shows an arrangement of graphical representations in GUI 304B after one or more new graphical representations are added to the page layout of GUI 304A based on the user input 306. As shown in GUI 304B, the graphical representations 312, 314, 316 and 318 have been resized and repositioned in comparison to GUI 304A, to make space for the new graphical representations 320, 322, 324, 326 and 328. Based on the grid rules of the underlying page layout, the device 100 has made the dimensions of all the graphical representations (and correspondingly, that of their associated frames in the underlying page layout) to be similar to one another. Additionally, the device 100 has positioned the graphical representations (and correspondingly, that of their associated frames in the underlying page layout) symmetrically spaced apart from one another and centered in the page.

In some implementations, the recursive automatic adjustments to the frames in a page layout to add new frames may be made for files of different content types. For example, a common layout may be used for files of different content types. Whenever the user adds an image file, video file, map frame, or text file, the device may adjust existing frames in the layout, irrespective of the content types.

In some implementations, the recursive automatic adjustments to the frames in a page layout to add new frames may be filtered based on file content types. For example, the page layout may use different grids for files of different content types. Whenever the user adds one or more new files, the device may check the content types of the files being added. For each newly-added file, the device may adjust existing frames in the grid layout that is used for arranging files with content type same as the newly-added file. If files of different content types are being added, then the device may adjust existing frames in different grid layouts, corresponding to the different content types of the newly-added files.

In the manner described above, upon receiving a user input to adjust a graphical representation in the GUI, the device may process the rules governing the underlying page layout in a recursive, automatic way until all violations of the rules are resolved. As noted previously, when a page layout includes a single grid layout, then the rules governing the page layout and the included grid layout may be the same. However, when a page layout includes multiple grid layouts, then the rules governing the page layout may be a combination of individual rules governing the included grid layouts.

In some implementations, one or more of grid layouts, e.g., 202, 203, 204 or 205, may be a center-aligned grid layout (also referred to as center alignment grid), in which the centers of the file graphical representations are aligned in the grid. For example, the centers 206A, 208A, 210A, etc., of the respective specified frames 206, 208, 210, etc., may be aligned at the intersection points of rows and columns of the grid layout 202. The graphical representations 106, 108, 110, etc., may be arranged in the grid layout 202 such that the centers of the graphical representations align with the centers of their respective specified frames in the layout, such as 206A, 208A, 210A, etc.

In a center alignment grid layout, if a user input is received to move a graphical representation, e.g., a photo or text frame, the item will be automatically adjusted to slide such that its center point aligns with the nearest grid intersection point in the layout. The rules associated with the grid layout may additionally specify that no two frames share the same grid intersection point. In such a case, once a graphical representation is moved by the user to the center point of a given frame in the grid layout, the device will evaluate all other graphical representations in the layout to see if any of their center points fall on the same grid intersection point. If a graphical representation is determined to violate the grid layout rules, the device will identify an unoccupied grid intersection point by examining the grid layout in a clockwise or counter-clockwise rotation. Once an unoccupied grid intersection point is found, the violating graphical representation will be moved to the unoccupied grid intersection point. If no neighboring grid intersection point is unoccupied, the device may elect to move the violating graphical representation to an occupied frame and then iterate for remaining graphical representations to push them out further. This process may repeat until all graphical representations adhere to the grid layout rule that no two graphical representations may occupy the same grid intersection point in the layout.

Similar to the grid layout 202, the grid layout 207 also may be a center alignment grid. However, the areas covered by the frames 219, 221 and 223 in the grid layout 207 can be different, provided that the center point of each frame is anchored at a grid intersection point, as dictated by the center alignment grid rule. The varying frame sizes in the grid layout 207 may be determined by some other metric, for example grid intersection lines. The center alignment grid layout may specify that the center point of a frame be anchored to an intersection, while the size and/or edges of the frame may adhere to a refinement of the grid rule (for example, the frame may be sized based on grid cell sizing). For example, the grid layout 207 may correspond to a center alignment grid with a frame sizing rule of “multiples of cell size.” Accordingly, the centers 221A, 223A or 219A of the respective frames 221, 223 or 219 may be aligned at intersection points of rows and columns of the grid layout 207, while the sizes of the frames may be different. As shown in the grid layout 207, each of frames 221 or 223 corresponds to a cell size and covers one grid intersection point. In contrast, frame 219 is of a larger size corresponding to multiple cells and spans multiple grid intersection points, but the center 219A of frame 219 is anchored at an intersection point in the grid layout.

In some implementations, the grid layout rules may specify the positioning of the frames, but may not specify the frame sizes. For example, a page layout may include a center alignment grid layout that specifies a position to anchor each frame, but the page layout may not have any particular rule about the size of a frame. Further, although the grid layout 202 or 207 shows spaces between the frames, in some implementations, the frames in a center alignment grid layout may not have any space between some or all of the frames. For example, in some implementations frames 208 and 209 in the grid layout 202 may partially overlap with no space between the frames, as long as the respective center points 208A and 209A are anchored at grid intersection points. As another example, frames 223 and 219 in the grid layout 207 may partially overlap, as long as the respective center points 223A and 219A are anchored at grid intersection points. Other suitable arrangements also may be possible with a center alignment grid layout.

In some implementations, one or more of the grid layouts, e.g., 202, 203, 204 or 205, may be a no-overlap grid layout (also referred to as no-overlap grid) in which a frame (e.g., associated with a graphical representation shown in the GUI) in the grid layout may be allowed to be positioned anywhere on a symmetrical or asymmetrical grid so long as the frame does not overlap with another frame. In such implementations, if a user input is received to adjust the position of a graphical representation (e.g., 108) in the GUI, the device 100 may automatically align the corresponding frame (e.g., 208) to the nearest grid intersection point. Additionally, the device 100 may resize the frame to ensure that edges of the frame match vertical and horizontal grid lines. Then the device may evaluate all remaining frames in the grid layout to ensure that the frames satisfy the associated grid layout rules, e.g., determining that edges and alignment points of the frames fall on grid lines/intersections, but not overlapping with other frames in the layout. This may correspond to graphical representations in the GUI 104A, e.g., 106, 108, 110, etc., occupying their respective frames in the grid layout 202 such that they are aligned with the grid lines without overlapping with each other.

The device may evaluate the frames in a recursive manner (e.g., one frame at a time) until the positions of all the frames in the grid layout are determined to satisfy the grid layout rules. In some implementations, the evaluation may be performed following a winding rule, i.e., by adjusting the frames in either clockwise or counterclockwise order to maintain a sense of order and an expected (i.e., consistent) result.

In some implementations, one or more of grid layouts, e.g., 202, 203, 204 or 205, may be a no-gap grid layout (also referred to as no-gap grid) in which a frame (e.g., associated with a graphical representation shown in the GUI) in the grid layout may be allowed to be positioned anywhere on a symmetrical or asymmetrical grid, but no space in the grid layout may be left unfilled. In such implementations, a frame in a grid layout (e.g., 206, 208, 210, etc. in grid layout 202 or 212, 214, 215, 216, 217, 218, etc., in grid layout 204) is positioned to be adjacent to another frame in the grid layout.

In such implementations, if a user input is received to adjust a graphical representation (e.g., 108) in the GUI, e.g., by resizing the graphical representation (and correspondingly resizing the associated frame, e.g., 208, in the grid layout), the device 100 may automatically evaluate the position and size of a frame immediately adjacent (e.g., 209) to the original edge of the resized frame. The device 100 may adjust the size of the adjacent frame (e.g., 209) such that the frame's edge remains touching the modified edge of the frame adjusted by the user (e.g., 208). Then the device may re-adjust all other frames in the grid layout to remove any remaining gaps. In some implementations, the device may perform this recursive evaluation following a winding rule, i.e., adjusting the frames in either a clockwise or counterclockwise order to ensure predictability of the arrangement of the graphical representations in the GUI, as viewed by the user.

As noted above, in some implementations, the rules associated with a page layout may be a combination of several different rules. For example, the rules associated with the page layout 200D may combine the no-gap grid rule with the no-overlap grid rule. In such implementations, the device 100 may first check the arrangement of the graphical representations in the GUI, and correspondingly the positions of the frames in the page layout, based on the no-overlap grid rule, since new gaps may be created to satisfy the no-overlap grid rule. Subsequently, the device may check the page layout using the no-gap grid rule to resolve any violations of that rule.

When a page layout, such as 200D, includes multiple grids, a first grid (e.g., 202) may be used for image files, a second grid (e.g., 203) may be used for video files or map frames, a third grid (e.g., 205) may be used for text files, and an additional grid may be used for art embellishments in the layout. The multiple grids may overlap completely to cover the entire page layout space. Alternatively, the different grids may occupy distinct regions. For example, the rules associated with the page layout may specify that all image files be in the left-half of the page aligning to their grid (e.g., 202), while all text files be in the right-half of the page aligning to their own distinct grid (e.g., 205).

In some implementations, the rules associated with a page layout may specify clear zones in the layout where graphical representations and associated frames are not allowed to be present. In such implementations, an edge of a frame may be adjacent to an edge of a clear zone, but may not fill the clear zone. In some implementations, the rules may specify that a frame is allowed to span a clear zone if the size of the frame is greater than the size of the clear zone itself.

In some implementations, the rules associated with a page layout may include uniform gutter spacing rules, which specify that edges of frames corresponding to graphical representations are at a predetermined distance (referred to as the gutter) from each other without touching. In some implementations, the gutters may be applied for discrete grid lines (horizontal or vertical) in a page layout that includes asymmetrical gutter spacing (e.g., page layout 200C in which the distances between frames may be asymmetrical).

In some implementations, the arrangement of graphical representations in a GUI (e.g., 104A) may follow a page layout that is based on a print product theme, i.e., a specific arrangement of frames in the page layout configured for printing the ordered display of graphical representations as a calendar, greeting card, etc. The print product theme may specify a default set of grids included in the page layout used in the theme. In some implementations, the number of grids that are included in the page layout used in the theme may be unlimited.

In some implementations, the print product theme may be designed such that the user is allowed to modify an individual page layout by changing the default set of grids with a locally-defined set of grids that are used for the particular page layout. For example, a page layout specified in a print product theme may include default grids for arranging graphical representations of image files, such as 202, and for arranging map frames, such as 203. The user may modify the page layout to include a grid for inserting text files into the print product theme, e.g., by adding the grid 205 for inserting graphical representations of text files along with image files and/or map frames.

In the manner described in the preceding sections, the device 100 may present in the GUI graphical representations of files that are arranged following predetermined rules associated with an underlying page layout. The graphical representations may be arranged in the page layout such that they are suitable for printing, e.g., as a photo collage or album, calendar, greeting card, etc. The device may allow the user to customize the arrangement of the graphical representations to suit the user's own preferences. The device may accommodate the user's customizations while maintaining the design intention of the arrangement specified by the page layout by automatically updating the graphical representations such that changes made based on the user input satisfy the rules associated with the page layout.

### Exemplary Procedures for Automatically Adjusting Page Layouts for File Arrangements

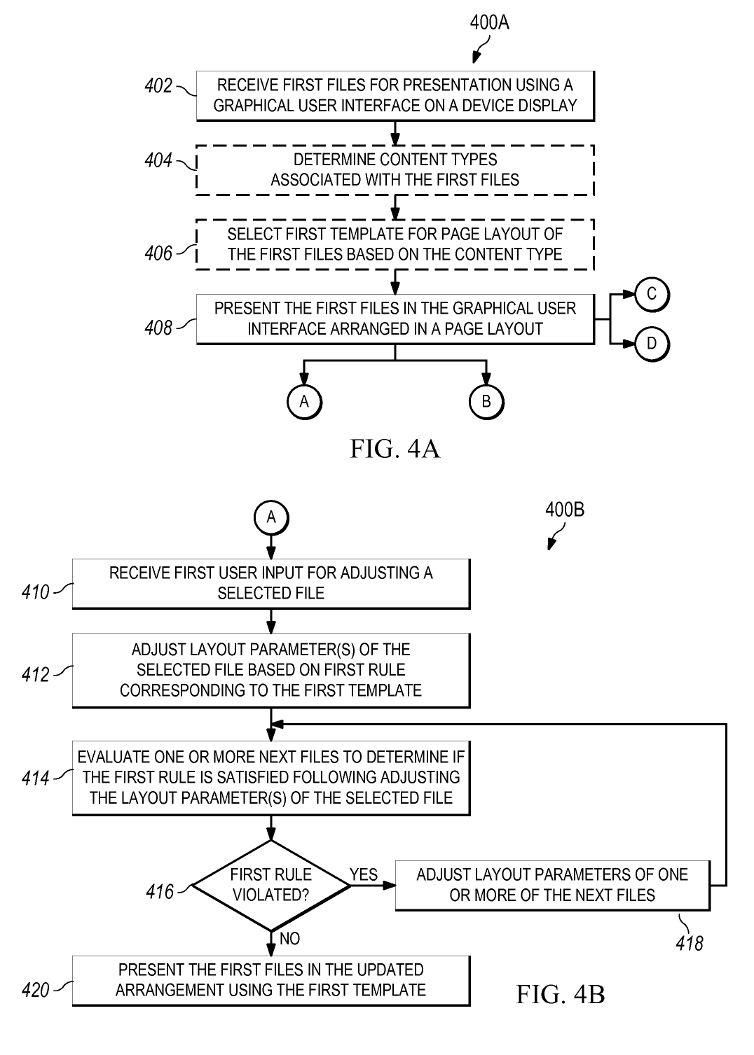

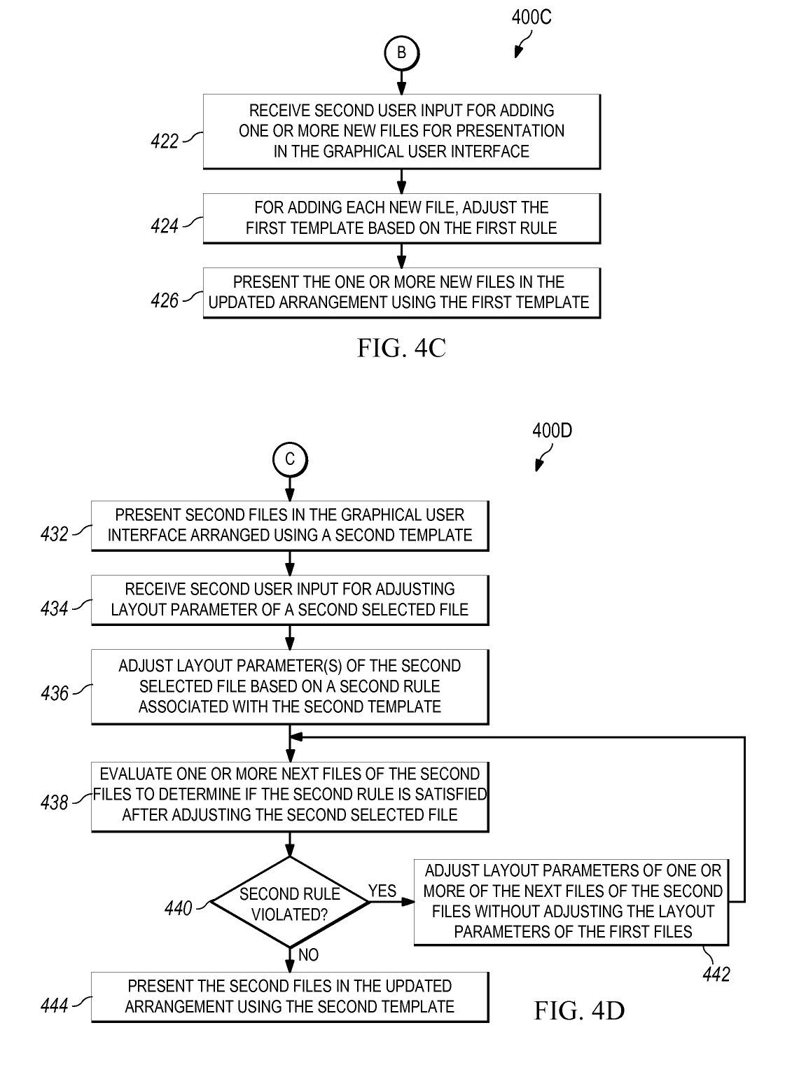

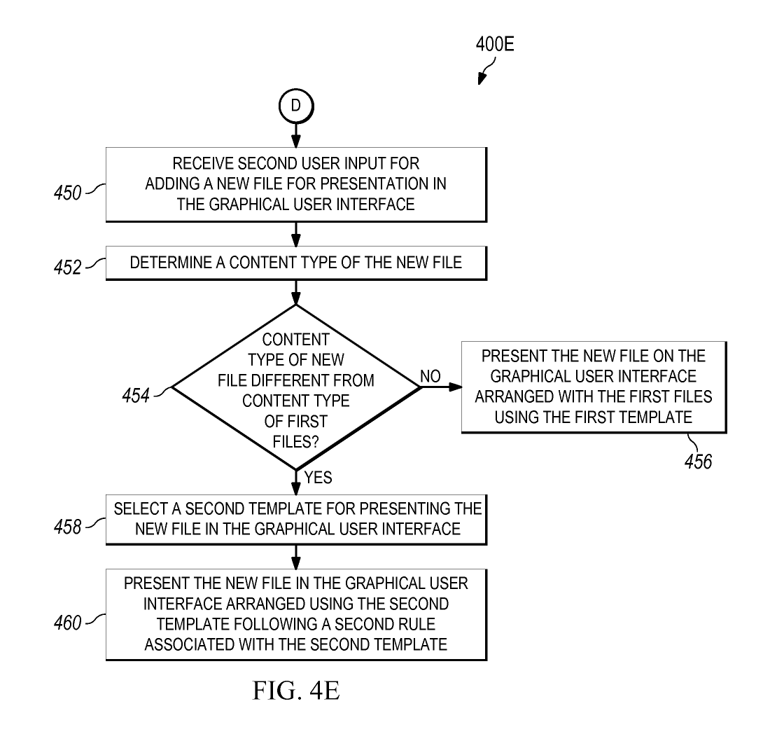

FIGS. 4A-4E are flowcharts illustrating exemplary processes 400A, 400B, 400C, 400D and 400E for automatically adjusting page layouts for file arrangements. One or more of the processes 400A, 400B, 400C, 400D or 400E may be used by a device to automatically adjust the positions of frames in a page layout to satisfy the rules governing the page layout when a user input is received for adjusting the position of a graphical representation of a file in a GUI that is based on the page layout. For example, one or more of the processes 400A, 400B, 400C, 400D or 400E may be used by the device 100 to adjust the page layout 200A (and/or the grid layout 202 included in page layout 200A) when user input 302 is received to adjust the graphical representation 108 in the GUI 104A, which may be based on the page layout 200A. Accordingly, the following section describes the processes 400A, 400B, 400C, 400D and 400E as being performed by the device 100. However, the processes 400A, 400B, 400C, 400D and 400E also may be performed by other devices, systems or system configurations.

In some implementations, the processes 400A, 400B, 400C, 400D and 400E are executed by hardware components of the device 100, such as processing circuitry, programmable hardware elements, ASICs, etc. In some other implementations, the processes 400A, 400B, 400C, 400D and 400E are executed by software running on the device 100, such as application software or operating system software that is configured to present the file arrangement on the device display, etc. The software may include instructions that are stored in memory coupled to the device 100, and may be executed by one or more processors included in the device 100.

As shown by process 400A in FIG. 4A, at 402, first files are received for presentation using a graphical user interface on a device display. For example, the device 100 may receive a user input to display an arrangement of graphical representations of files, such as 106, 108, 110, etc. The user input may be associated with showing the files using a print product theme, i.e., using a page layout that is conducive to printing as an album, a calendar, a greeting card, etc.

In some implementations, the content types associated with the first files are determined at 404. For example, in some implementations the device 100 may be configured to present files of different content types using different grids in a page layout. As described previously, the device 100 may use page layout 200D, in which image files (i.e., graphical representations thereof) may be arranged using the grid layout 202, video files and/or map frames may be arranged using the grid layout 203 and text files may be arranged using the grid layout 205. The device 100 may check the content type associated with each file that is to be represented in the page layout to determine the grid layout in which the file is to be included.

In some implementations, at 406 a first template is selected for layout of the first files based on the content type. Continuing with the above example, if the device 100 determines that a file is of content type image (e.g., the file may be a photo) then the device selects the grid layout 202 for arranging the file. On the other hand, if the device 100 determines that a file is of content type video, then the device selects the grid layout 203 for arranging the file. Alternatively, if the device 100 determines that a file is of content type text, then the device selects the grid 205 for arranging the file.

In this context, in some implementations a template may refer to a page layout, such as 200A. This may be the case, for example, when a page layout includes a single grid such that the terms page layout and grid layout may be used interchangeably, as noted previously. In some other implementations, a template may refer to a grid layout that is included in a page layout, e.g., grid layout 202 or 205. This may be the case, for example, when a page layout includes multiple grids.

In some implementations, the device may be configured to present files of different content types using a common grid in a page layout. For example, the device 100 may use page layout 200C and present files of different content types, such as image, video, map frames, text files, etc. using the same grid layout 204. In such implementations, the content type associated with the first files may not be determined at 404, and/or a first template for layout of the first files may not be selected at 406 based on the file content type.

At 408, the first files are presented in the graphical user interface arranged in a page layout. For example, the device 100 may display graphical representations of files, such as 106, 108, 110, etc., arranged in the GUI 104A, which may be based on the page layout 200A. Additionally or alternatively, the device 100 may display graphical representations of files, such as 112, 114, 115, 116, 117, 118, etc., arranged in the GUI 104B, which may be based on the page layout 200C or the page layout 200D. The arrangement of the graphical representations in the GUI 104A or 104B may follow predetermined rules associated with the respective underlying page layout. The rules may be based on certain design intentions, for example, to enable printing the arrangement of graphical representations as a calendar, an album, a greeting card, or some other suitable form.

In some implementations, when the first files are presented in the GUI arranged in a page layout, a first user input is received for adjusting a selected file at 410, as shown by the process 400B in FIG. 4B. For example, the user may provide input 302 to move the graphical representation 108 in the GUI 104A, or to adjust the graphical representation in some other suitable manner.

At 412, the layout parameter(s) of the selected file are adjusted based on the first rule corresponding to the first template. For example, upon receiving the user input to adjust the graphical representation 108, the device 100 may adjust the frame 208 corresponding to the graphical representation 108 in the grid layout 202. The device 100 may move the frame 208 to a new position (e.g., position occupied by frame 210) if the user input was to move the graphical representation 108 to the position of the graphical representation 110. Additionally or alternatively, the device may change dimensions of the frame 208, for example, if the user input was to resize the graphical representation 108.

At 414, one or more next files are evaluated to determine if the first rule is satisfied following adjusting the layout parameter(s) of the selected file. For example, the device 100 may make adjustments to the frame 208 when a user input is received to adjust the graphical representation 108 in the GUI 104A. When the frame 208 is adjusted based on the user input, other frames also may be adjusted. In some implementations, the device may examine a first frame that is adjacent to the frame 208 to determine if the first frame is to be adjusted to satisfy the rules governing the page layout. For example, the device may reposition frame 210 to make space for moving the frame 208 if the user input is to move the graphical representation 108 to the position occupied by graphical representation 110. Accordingly, the device 100 may automatically evaluate or examine one or more frames in the page layout that are next to (i.e., adjacent to or within a certain vicinity of) the frame corresponding to the user-selected graphical representation to check whether one or more rules governing the page layout are violated when the user-selected frame is adjusted.

At 416, the device determines whether the first rule is violated. For example, when frame 208 is adjusted in the grid layout 202, the device 100 may evaluate one or more frames that are next to (i.e., adjacent to or within a certain vicinity of) the frame 208 and determine that one or more rules associated with the grid layout 202 are violated when the frame 208 is adjusted.

If the device determines that the first rule is violated, then at 418 layout parameters of one or more of the next files are adjusted. For example, the device 100 may determine that when frame 210 is moved to accommodate the user-specified adjustment to frame 208, then a rule associated with the grid layout 202 is violated. For example, the rule may include center alignment grid rule, and adjusting the frame 208 and/or the frame 210 may result in these frames sharing a common grid intersection point with one or more other frames in the vicinity, which may be a violation of the rule. Alternatively, the rule may include no-overlap grid rule, and adjusting the frame 208 and/or the frame 210 may result in these frames overlapping with one or more adjacent frames in the grid, which may be a violation of the rule. Alternatively, the rule may include no-gap grid rule, and adjusting the frame 208 and/or the frame 210 may result in a gap being created between these frames and one or more adjacent frames in the grid, which may be a violation of the rule. If the device 100 determines that a grid rule is violated, then the device 100 may adjust layout parameters of one or more frames in the grid that are next to the frame 208 and/or the frame 210, until all violations of the grid rule are resolved.

The device may perform the automatic adjustments recursively. For example, after an adjustment is made at 418, the device may evaluate, at 414, one or more additional frames that are next to the adjusted frames (e.g., either adjacent to, or in a certain vicinity of, the frame 208, the frame 210, or another frame next to 208 and/or 210 that has been adjusted at 418). Based on evaluating these additional frames, the device may determine at 416 whether the first rule is still violated.

If the device determines that the first rule is satisfied, then at 420 the first files are presented in the updated arrangement using the first template. For example, the device 100 may resolve all violations of the page layout rule(s) following 414, 416 and 418. Alternatively, the adjustment to a user-selected graphical representation may not lead to a violation of the page layout rule. In either case, the device 100 may cease performing automatic adjustments to the frames in the page layout, and present the graphical representations in an updated arrangement in the GUI, e.g., similar to that shown in GUI 104A or 104B, with the graphical representations suitably modified based on the user input and/or automatic adjustments. The updated arrangement may satisfy the rule(s) associated with the underlying page layout, such that the design intention of the page layout is preserved.

In some implementations, when the first files are presented in the GUI arranged in a page layout at 408, a second user input is received at 422 for adding one or more new files for presentation in the graphical user interface, as shown by the process 400C in FIG. 4C. For example, the user may provide input to add graphical representations of one or more new files to the GUI 104A (or GUI 104B).

At 424, the first template is adjusted based on the first rule for adding each new file. For example, in response to receiving the user input to add graphical representations of one or more new files to the GUI 104A, the device 100 may automatically position each file in one of the frames specified in the page layout 200A. For each new file that is positioned in a frame in the page layout, the device may check whether the rules associated with the page layout are satisfied when the new file is added to the page layout. For example, the frame 211 may be empty, and the device may position the graphical representation associated with a newly-added file in the frame 211, ensuring that rules corresponding to the grid layout 202 are satisfied.

Alternatively, as described with respect to GUIs 304A and 304B, when user input 306 is received to add one or more new files to the GUI, the device 100 may recursively adjust the dimensions and/or positions of existing frames in the underlying page layout to accommodate a new frame for each new file being added. Adjustments to existing frames in the page layout may be performed in a manner such that a suitable arrangement consistent with the overall thematic design of the page layout is achieved, while satisfying the grid rules.

At 426, the one or more new files are presented in the updated arrangement using the first template. For example, the device 100 may present graphical representations of existing and new files in an updated arrangement in the GUI, e.g., similar to the arrangement shown in GUI 104A or 104B, with the graphical representations suitably modified based on the user input and/or automatic adjustments. The updated arrangement may satisfy the rule associated with the underlying page layout, such that the design intention of the page layout is preserved.

In some implementations, in addition to presenting the first files in the GUI arranged in a page layout at 408, the device may present second files in the graphical user interface arranged using a second template at 432, as shown by the process 400D in FIG. 4D. For example, the device 100 may use different page layouts, or different grids in a page layout, to arrange files of different content types. As described previously, using the page layout 200D, the device 100 may present image files (i.e., graphical representations thereof) following the grid layout 202, and present text files following the grid layout 205. The device 100 may check the content type associated with each file that is to be represented in the page layout to determine the grid layout in which the file is to be included.

In such implementations, a second user input is received for adjusting the layout parameter of a second selected file at 434. For example, the user may provide an input to adjust the graphical representation of text file 116 in the GUI 104B.

At 436, the layout parameter(s) of the second selected file are adjusted based on a second rule associated with the second template. For example, upon receiving the user input to adjust the graphical representation 116, the device 100 may adjust a frame corresponding to the graphical representation 116 in the grid layout 205. The device 100 may move the frame corresponding to the graphical representation 116 to a new position if the user input was to move the graphical representation 116. Additionally or alternatively, the device may change the dimension of the frame corresponding to the graphical representation 116, for example if the user input was to resize the graphical representation 116. In some implementations, the device 100 may adjust one or more frames in the grid layout 205 without affecting the grid layout 203 that is concurrently used to display an arrangement of image files in the GUI 104B.

At 438, one or more next files of the second files are evaluated to determine if the second rule is satisfied after adjusting the second selected file. For example, the device 100 may make adjustments to a frame corresponding to the graphical representation 116 in the grid layout 205 when a user input is received to adjust the graphical representation 116 in the GUI 104B. When the frame is adjusted based on the user input, other frames in the grid layout 205 also may be adjusted. In some implementations, the device may initially examine a frame that is adjacent to the frame corresponding to the graphical representation 116 to determine if the first frame is to be adjusted to satisfy the rules governing the grid layout 205. The device may reposition the adjacent frame to make space for moving the frame corresponding to the graphical representation 116 if the user input is to move the graphical representation 116 to a different position in the GUI 104B. Accordingly, the device 100 may automatically evaluate or examine one or more frames in the grid layout 205 that are next to (i.e., adjacent to or within a certain vicinity of) the frame corresponding to the user-selected graphical representation 116 to check whether one or more rules governing the grid layout 205 are violated when the frame corresponding to the user-selected graphical representation 116 is adjusted.

At 440, the device determines whether the second rule is violated. For example, the device 100 may automatically determine whether an adjustment to the frame corresponding to the graphical representation 116 in the grid layout 205 violates one or more rules associated with the grid layout 205.

If the device determines that the second rule is violated, then at 442 layout parameters of one or more of the next files of the second files are adjusted without adjusting the layout parameters of the first files. For example, the device 100 may determine that when the frame corresponding to the graphical representation 116 in the grid layout 205 is adjusted based on the user input, then a rule associated with the grid layout 205 is violated. In some implementations, the rule may include center alignment grid rule, and adjusting the frame corresponding to the graphical representation 116 may result in this frame sharing a common grid intersection point with another frame that is adjacent to it or within a certain vicinity of it, which may be a violation of the rule. Alternatively, the rule may include no-overlap grid rule, and adjusting the frame corresponding to the graphical representation 116 may result in this frame overlapping with an adjacent frame in the grid, which may be a violation of the rule. Alternatively, the rule may include no-gap grid rule, and adjusting the frame corresponding to the graphical representation 116 may result in a gap being created between this frame and an adjacent frame in the grid, which may be a violation of the rule. If the device 100 determines that a grid rule is violated, then the device 100 may automatically adjust layout parameters of one or more frames in the grid layout 205 that are next to the frame corresponding to the graphical representation 116 until all violations of the grid rule are resolved.

The device may perform the automatic adjustments recursively. For example, after an adjustment is made at 442, the device may evaluate, at 438, one or more additional frames that are adjacent to, or in the vicinity of, the frames adjusted previously at 442. Based on evaluating these additional frames, the device may determine at 440 whether the second rule associated with the grid layout used for the text files is still violated.

Any adjustments made to frames in the grid layout 205 may be limited to the grid layout 205. The device 100 may perform these adjustments without affecting the grid layout 203 that is used concurrently in the same page layout, e.g., to arrange image files in the GUI. In this manner, when different page layouts, or different grids in a page layout, are used to arrange files of different content types, then the device may automatically adjust one or more of the different page layouts or grids layouts independent of one another. Thus the device 100 may ensure that automatic adjustments that are made to arrangement of files of one content type do not affect arrangements of files other content types that are simultaneously displayed.

If the device determines at 440 that the second rule is not violated, then at 444 the second files are presented in the updated arrangement using the second template. For example, the device 100 may resolve all violations of the grid layout rule(s) for text files following 438, 440 and 442. Alternatively, the adjustment to a user-selected graphical representation of a text file may not lead to a violation of a rule for the layout grid used for text files. In either case, the device 100 may cease performing automatic adjustments to the frames corresponding to the text files in the page layout, and present the graphical representations of the text files in an updated arrangement in the GUI, e.g., similar to that shown in GUI 104B, with the graphical representations suitably modified based on the user input and/or automatic adjustments. The updated arrangement of the text files may satisfy the rule associated with the underlying grid layout, e.g., 205, such that the design intention of the page layout is preserved. Additionally, graphical representations of files of other content types, e.g., image files, are also presented in the GUI, arranged following a different grid layout, e.g., 203. The arrangement of files of the other content types may be presented without any adjustments, even though the arrangement of the text files may be updated.

In some implementations, when the first files are presented in the GUI arranged in a page layout at 408, a second user input is received at 450 for adding a new file for presentation in the graphical user interface, as shown by the process 400E in FIG. 4E. For example, the user may provide input to add the graphical representation of a new file to the GUI 104B, which includes image files, video files, map frames, and/or text files, as described previously.

The content type associated with the new file is determined at 452. For example, in some implementations the device 100 may be configured to present files of different content types using different page layouts, or different grids in a page layout, as described previously. In such implementations, the device 100 may check the content type associated with a new file when user input is received to add the new file to the GUI.

At 454, the device determines whether the content type of the new file is different from the content type of first files. If the device determines that the content type of the new file is not different from the content type of the first files, then at 456 the new file is presented on the graphical user interface arranged with the first files using the first template. For example, the first files (or graphical representations thereof) that are presented in the GUI may be image files, and the new file that is to be added also may be an image file. In such a case, the device 100 adds the new file to a position in an existing page layout that is used for the image files, following the rules associated with the page layout, and presents the arrangement of the image files, including the new file, in the GUI.

On the other hand, if the device determines that the content type of the new file is different from the content type of the first files, then at 458 a second template is selected for presenting the new file on the graphical user interface. For example, the first files (or graphical representations thereof) that are presented in the GUI may be image files that are arranged using the grid layout 202, but the new file that is to be added may be a text file. Accordingly, the device may select a different grid layout, e.g., grid layout 205, for presenting the newly-added text file in the GUI.

At 460, the new file is presented in the graphical user interface arranged using the second template following a second rule associated with the second template. For example, the device 100 may select the grid layout 205 for presenting the newly-added text file and add the text file to a frame of the grid layout 205 following a rule governing the grid layout 205. Then the device may present graphical representation of the text file in the GUI 104B, e.g., similar to the graphical representation 116, based on the arrangement specified by the underlying grid layout 205. Concurrently, the device may present graphical representations of the image files in the GUI 104B, e.g., similar to the graphical representations 114 and 115, which may be arranged based on the grid layout 202. The arrangement of files of different content types may satisfy the rules associated with the respective underlying grid layouts such that the design intention of the overall page layout is preserved.

### Exemplary Device Architecture

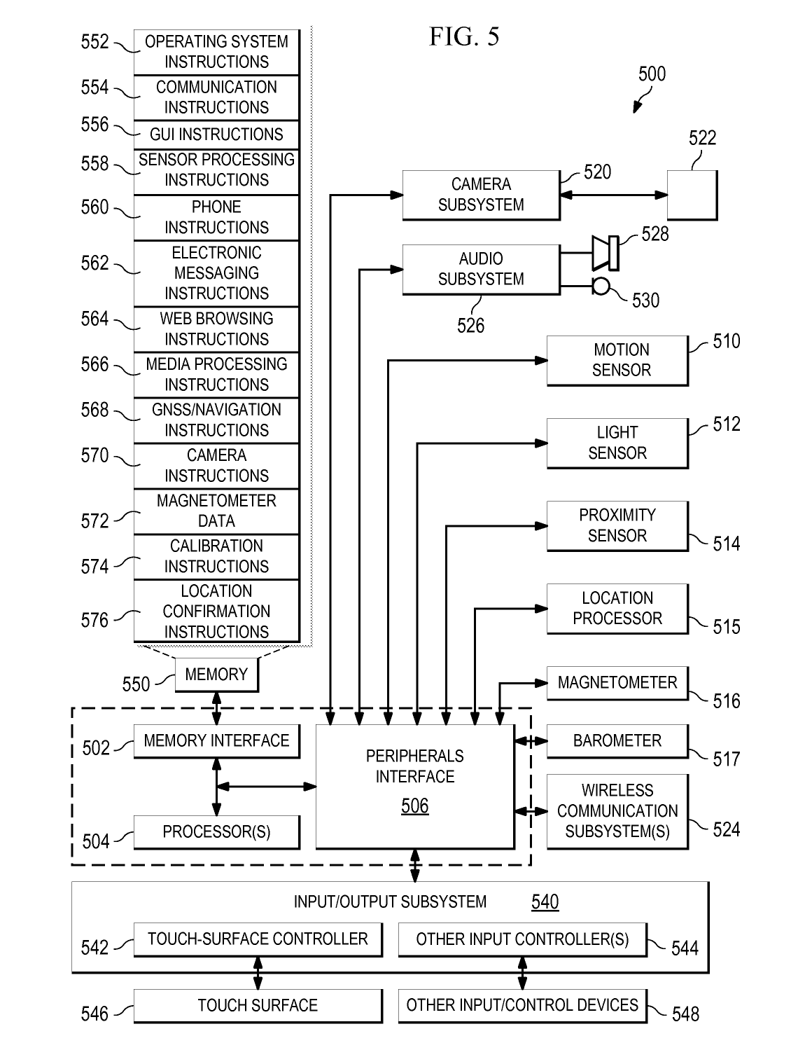

FIG. 5 is a block diagram illustrating exemplary device architecture 500 of an electronic device implementing the features and operations of FIGS. 1A-1B, 2A-2D, 3A-3C and 4A-4E. In some implementations, the device architecture 500 may correspond to the architecture of the user device 100. An electronic device (e.g., the device 100) can include memory interface 502, one or more data processors, image processors and/or processors 504, and peripherals interface 506. Memory interface 502, one or more processors 504 and/or peripherals interface 506 can be separate components or can be integrated in one or more integrated circuits. Processors 504 can include application processors, baseband processors, and wireless processors. The various components in the mobile device, for example, can be coupled by one or more communication buses or signal lines.

Sensors, devices, and subsystems can be coupled to peripherals interface 506 to facilitate multiple functionalities. For example, motion sensor 510, light sensor 512, and proximity sensor 514 can be coupled to peripherals interface 506 to facilitate orientation, lighting, and proximity functions of the mobile device. Location processor 515 (e.g., a Global Navigation Satellite System (GNSS) receiver) can be connected to peripherals interface 506 to provide geopositioning. Electronic magnetometer 516 (e.g., an integrated circuit chip) can also be connected to peripherals interface 506 to provide data that can be used to determine the direction of magnetic North. Thus, electronic magnetometer 516 can be used as an electronic compass. Motion sensor 510 can include one or more accelerometers configured to determine change of speed and direction of movement of the mobile device. Barometer 517 can include one or more devices connected to peripherals interface 506 and configured to measure pressure of atmosphere around the mobile device.

Camera subsystem 520 and an optical sensor 522, e.g., a charged coupled device (CCD) or a complementary metal-oxide semiconductor (CMOS) optical sensor, can be utilized to facilitate camera functions, for example, recording photographs and video clips.

Communication functions can be facilitated through one or more wireless communication subsystems 524, which can include radio frequency receivers and transmitters and/or optical (e.g., infrared) receivers and transmitters. The specific design and implementation of the communication subsystem 524 can depend on the communication network(s) over which a mobile device is intended to operate. For example, a mobile device can include communication subsystems 524 designed to operate over a GSM network, a GPRS network, an EDGE network, a Wi-Fi™ or WiMAX™ network, and a Bluetooth™ network. In particular, the wireless communication subsystems 524 can include hosting protocols such that the mobile device can be configured as a base station for other wireless devices.

Audio subsystem 526 can be coupled to a speaker 528 and a microphone 530 to facilitate voice-enabled functions, for example, voice recognition, voice replication, digital recording, and telephony functions. Audio subsystem 526 can be configured to receive voice commands from the user.

I/O subsystem 540 can include touch surface controller 542 and/or other input controller(s) 544. Touch surface controller 542 can be coupled to a touch surface 546 or pad. Touch surface 546 and touch surface controller 542 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 546. Touch surface 546 can include, for example, a touch screen.

Other input controller(s) 544 can be coupled to other input/control devices 548, for example, one or more buttons, rocker switches, thumb-wheel, infrared port, USB port, and/or a pointer device, for example, a stylus. The one or more buttons (not shown) can include an up/down button for volume control of speaker 528 and/or microphone 530.

In one implementation, a pressing of the button for a first duration may disengage a lock of the touch surface 546; and a pressing of the button for a second duration that is longer than the first duration may turn power to the mobile device on or off. The user may be able to customize a functionality of one or more of the buttons. The touch surface 546 also can be used, for example, to implement virtual or soft buttons and/or a keyboard.

In some implementations, a mobile device can present recorded audio and/or video files, such as MP3, AAC, and MPEG files. In some implementations, the mobile device can include the functionality of an MP3 player. The mobile device may, therefore, include a pin connector that is compatible with the iPod. Other input/output and control devices can also be used.

Memory interface 502 can be coupled to memory 550. Memory 550 can include high-speed random access memory and/or non-volatile memory, such as one or more magnetic disk storage devices, one or more optical storage devices, and/or flash memory (e.g., NAND, NOR). Memory 550 can store operating system 552, such as Darwin, RTXC, LINUX, UNIX, OS X, WINDOWS, iOS, or an embedded operating system such as VxWorks. Operating system 552 may include instructions for handling basic system services and for performing hardware dependent tasks. In some implementations, operating system 552 can include a kernel (e.g., UNIX kernel).

Memory 550 may also store communication instructions 554 to facilitate communicating with one or more additional devices, one or more computers and/or one or more servers. Memory 550 may include graphical user interface (GUI) instructions 556 to facilitate graphic user interface processing; sensor processing instructions 558 to facilitate sensor-related processing and functions; phone instructions 560 to facilitate phone-related processes and functions; electronic messaging instructions 562 to facilitate electronic-messaging related processes and functions; web browsing instructions 564 to facilitate web browsing-related processes and functions; media processing instructions 566 to facilitate media processing-related processes and functions; GNSS/Navigation instructions 568 to facilitate GNSS (e.g., GPS) and navigation-related processes and instructions; camera instructions 570 to facilitate camera-related processes and functions; magnetometer data 572 and calibration instructions 574 to facilitate magnetometer calibration. The memory 550 may also store other software instructions (not shown), such as security instructions, web video instructions to facilitate web video-related processes and functions, and/or web shopping instructions to facilitate web shopping-related processes and functions. In some implementations, the media processing instructions 566 are divided into audio processing instructions and video processing instructions to facilitate audio processing-related processes and functions and video processing-related processes and functions, respectively. An activation record and International Mobile Equipment Identity (IMEI) or similar hardware identifier can also be stored in memory 550. Memory 550 can store location confirmation instructions 576. Location confirmation instructions 576, upon execution, can cause processor 504 to perform operations of location-based processes.

Each of the above identified instructions and applications can correspond to a set of instructions for performing one or more functions described above. These instructions need not be implemented as separate software programs, procedures, or modules. Memory 550 can include additional instructions or fewer instructions. Furthermore, various functions of the mobile device may be implemented in hardware and/or in software, including in one or more signal processing and/or application specific integrated circuits.

### Exemplary Operating Environment

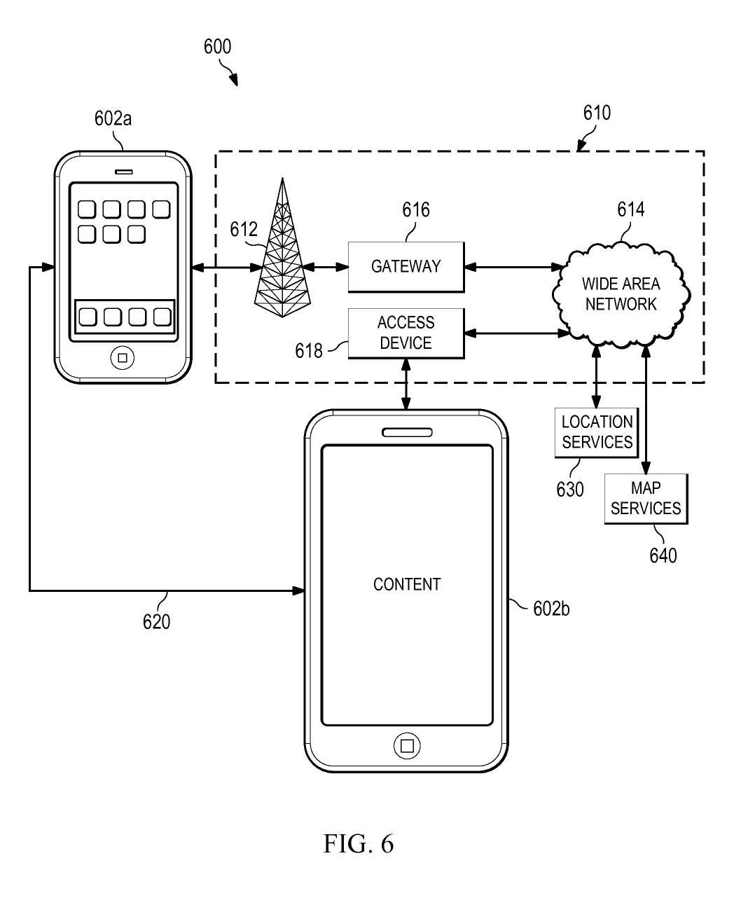

FIG. 6 is a block diagram of exemplary network operating environment 600 for the electronic devices implementing the features and operations of FIGS. 1A-1B, 2A-2D, 3A-3C, 4A-4E and 5. Each of electronic devices 602a and 602b can be a user device as described with reference to FIGS. 1A-1B, 2A-2D, 3A-3C, 4A-4E and 5. The devices 602a and 602b can communicate, for example, over one or more wired and/or wireless networks 610 in data communication. For example, a wireless network 612, e.g., a cellular network, can communicate with a wide area network (WAN) 614, such as the Internet, by use of a gateway 616. Likewise, an access device 618, such as an 802.11g wireless access point, can provide communication access to the wide area network 614.

In some implementations, both voice and data communications can be established over wireless network 612 and the access device 618. For example, device 602a can place and receive phone calls (e.g., using voice over Internet Protocol (VoIP) protocols), send and receive e-mail messages (e.g., using Post Office Protocol 3 (POP3)), and retrieve electronic documents and/or streams, such as web pages, photographs, and videos, over wireless network 612, gateway 616, and wide area network 614 (e.g., using Transmission Control Protocol/Internet Protocol (TCP/IP) or User Datagram Protocol (UDP)). Likewise, in some implementations, the device 602b can place and receive phone calls, send and receive e-mail messages, and retrieve electronic documents over the access device 618 and the wide area network 614. In some implementations, device 602a or 602b can be physically connected to the access device 618 using one or more cables and the access device 618 can be a personal computer. In this configuration, device 602a or 602b can be referred to as a “tethered” device.

Devices 602a and 602b can also establish communications by other means. For example, device 602a can be a wireless device that communicates with other wireless devices, e.g., mobile devices, cell phones, etc., over the wireless network 612. Likewise, devices 602a and 602b can establish peer-to-peer communications 620, e.g., a personal area network, by use of one or more communication subsystems, such as the Bluetooth™ communication devices. Other communication protocols and topologies can also be implemented.

Device 602a or 602b can communicate, for example, with one or more services 630 and 640 over the one or more wired and/or wireless networks. For example, one or more location services 630 can provide representations of addresses or and associated assumed locations for confirmation. Map services 640 can provide a virtual map for display. The virtual map can include addresses of land features that are confirmed by a user device.

Device 602a or 602b can also access other data and content over the one or more wired and/or wireless networks. For example, content publishers, such as news sites, Really Simple Syndication (RSS) feeds, web sites, blogs, social networking sites, developer networks, etc., can be accessed by device 602a or 602b. Such access can be provided by invocation of a web browsing function or application (e.g., a browser) in response to a user touching, for example, a Web object.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

### Exemplary System Architecture

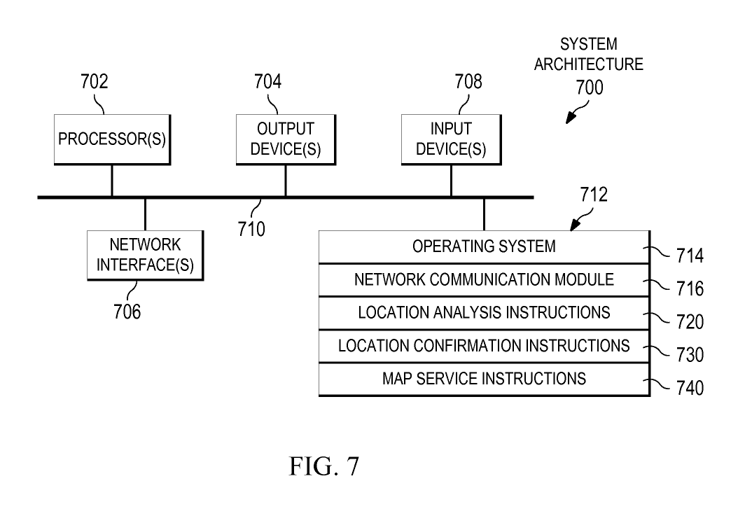

FIG. 7 is a block diagram of exemplary system architecture 700 for implementing the features and operations of FIGS. 1A-1B, 2A-2D, 3A-3C, 4A-4E, 5 and 6. Other architectures are possible, including architectures with more or fewer components. System architecture 700 can be implemented by components of an electronic device, e.g., device 100. In some implementations, architecture 700 includes one or more processors 702 (e.g., dual-core Intel® Xeon® Processors), one or more output devices 704 (e.g., LCD), one or more network interfaces 706, one or more input devices 708 (e.g., mouse, keyboard, touch-sensitive display) and one or more computer-readable mediums 712 (e.g., RAM, ROM, SDRAM, hard disk, optical disk, flash memory, etc.). These components can exchange communications and data over one or more communication channels 710 (e.g., buses), which can utilize various hardware and software for facilitating the transfer of data and control signals between components.

The term “computer-readable medium” refers to any medium that participates in providing instructions to processor 702 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 712 can further include operating system 714 (e.g., Mac OS® server, Windows Server®, or iOS®), network communication module 716, location analysis instructions 720, location confirmation instructions 730, and map service instructions 740. Operating system 714 can be multi-user, multiprocessing, multitasking, multithreading, real time, etc. Operating system 714 performs basic tasks, including but not limited to: recognizing input from devices 708 and providing output to devices 704; keeping track and managing files and directories on computer-readable medium 712 (e.g., memory or a storage device); controlling peripheral devices; and managing traffic on the one or more communication channels 710. Network communications module 716 includes various components for establishing and maintaining network connections (e.g., software for implementing communication protocols, such as TCP/IP, HTTP, etc.). Location analysis instructions 720 can include instructions that, when executed, causes processor 702 to perform operations of a significant location subsystem. Location confirmation instructions 730 can include instructions that, when executed, causes processor 702 to perform server-side operations. Map service instructions 740 can include instructions that, when executed, causes processor 702 to provide map information to user devices. The map information can include confirmed locations of street addresses.

Architecture 700 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of examples and implementations of the invention have been described. Nevertheless, it will be understood that various modifications and enhancements to the described examples and implementations and other implementations can be made based on what is disclosed without departing from the spirit and scope of the invention.

What is claimed is:

1. A method comprising:
presenting a group of first files on a graphical user interface shown on a device display using a first template, wherein presentation of the group of first files on the graphical user interface using the first template is controlled by a first rule associated with the first template;
receiving, through an input interface, a first user input for adjusting a layout parameter of a selected file of the group of first files;
in response to receiving the first user input, examining the first rule associated with the first template, wherein the first rule constrains adjustment of the layout parameter of the selected file;
adjusting the layout parameter of the selected file based on the first rule;
evaluating one or more next files in the group of first files to determine if the first rule is satisfied following adjusting the layout parameter of the selected file;
based on determining that the first rule is violated following adjusting the layout parameter of the selected file, recursively adjusting layout parameters of the one or more next files until the first rule is satisfied; and
updating the presentation of the group of first files using the first template based on recursively adjusting the layout parameters of the one or more next files.

2. The method of claim 1, further comprising:
receiving a second user input adding one or more new files to the group of first files for presentation on the graphical user interface; and
in response to receiving the second user input, adding the one or more new files to the group of first files, comprising:
for each file included in the one or more new files, adjusting the first template by performing the evaluating of a next file.

3. The method of claim 1, further comprising:
presenting a group of second files on the graphical user interface using a second template, wherein presentation of the group of second files using the second template is controlled by a second rule associated with the second template, and wherein the group of second files is presented in conjunction with presenting the group of first files using the first template;
receiving, through the input interface, a second user input for adjusting a layout parameter of a selected file of the group of second files;
in response to receiving the second user input, adjusting the layout parameter of the selected file of the group of second files based on the second rule;
evaluating one or more next files in the group of second files to determine if the second rule is satisfied following adjusting the layout parameter of the selected file of the group of second files;
based on determining that the second rule is violated, recursively adjusting layout parameters of the one or more next files in the group of second files until the second rule is satisfied; and
updating the presentation of the group of second files using the second template based on recursively adjusting the layout parameters of the one or more next files in the group of second files.

4. The method of claim 3, wherein recursively adjusting the layout parameters of the one or more next files in the group of second files comprises:
recursively adjusting the layout parameters of the one or more next files in the group of second files without adjusting layout parameters of the group of first files.

5. The method of claim 3, wherein updating the presentation of the group of second files using the second template comprises:
updating the presentation of the group of second files using the second template without updating the presentation of the group of first files.

6. The method of claim 1, wherein presenting the group of first files on the graphical user interface using the first template comprises:
determining a content type of the first files; and
selecting the first template based on the content type of the first files.

7. The method of claim 6, further comprising:
receiving a second user input adding a new file for presentation on the graphical user interface; and
in response to receiving the second user input, determining a content type of the new file;
determining that the content type of the new file is different from the content type of the first files;
based on determining that the content type of the new file is different from the content type of the first files, selecting a second template from device storage for presenting the new file on the graphical user interface, wherein the second template is associated with the content type of the new file; and
presenting the new file on the graphical user interface using the second template.

8. The method of claim 7, wherein presenting the new file on the graphical user interface using the second template is controlled by a second rule associated with the second template.

9. The method of claim 1, wherein a next file in the group of first files includes a file that is adjacent to the selected file, and wherein evaluating the one or more next files in the group of first files comprises:
identifying one or more files that are adjacent to the selected file;
evaluating the one or more adjacent files to determine if the first rule is satisfied following adjusting the layout parameter of the selected file;
based on determining that the first rule is violated following adjusting the layout parameter of the selected file, recursively adjusting layout parameters of the one or more adjacent files;
identifying one or more additional files in vicinity of the one or more adjacent files;
evaluating the one or more additional files to determine if the first rule is satisfied following adjusting layout parameters of the one or more adjacent files;
based on determining that the first rule is violated following adjusting the layout parameters of the one or more adjacent files, recursively adjusting layout parameters of the one or more additional files until the first rule is satisfied; and
updating the presentation of the group of first files using the first template based on adjusting the layout parameters of the one or more files and the one or more additional files.

10. The method of claim 1, wherein the first rule includes sub-rules, the method comprising:
arranging the sub-rules in a precedence order;
in response to receiving the first user input, adjusting the layout parameter of the selected file based on examining the sub-rules in the precedence order;
based on determining that one or more sub-rules are violated following adjusting the layout parameter of the selected file, recursively adjusting layout parameters of the one or more next files until a first sub-rule is satisfied, wherein the first sub-rule heads the one or more violated sub-rules in the precedence order; and
following satisfying the first sub-rule, recursively adjusting layout parameters of the one or more next files until a second sub-rule is satisfied, wherein the second sub-rule is after the first sub-rule in the precedence order.

11. The method of claim 1, wherein files included in the group of first files are associated with different content types.

12. The method of claim 1, wherein the first template is associated with a grid layout for arranging the group of first files on the graphical user interface.

13. The method of claim 12, wherein the grid layout includes one or more of a center alignment grid, a no-overlap grid, or a no-gap grid.

14. The method of claim 12, wherein the grid layout includes multiple grids, and wherein different grids correspond to different content types associated with files.

15. A non-transitory storage device storing instructions that, when executed by one or more processors, cause the one or more processors to perform operations comprising:
presenting a group of first files on a graphical user interface shown on a device display using a first template, wherein presentation of the group of first files on the graphical user interface using the first template is controlled by a first rule associated with the first template;
receiving, through an input interface, a first user input for adjusting a layout parameter of a selected file of the group of first files;
in response to receiving the first user input, examining the first rule associated with the first template, wherein the first rule constrains adjustment of the layout parameter of the selected file;
adjusting the layout parameter of the selected file based on the first rule;
evaluating one or more next files in the group of first files to determine if the first rule is satisfied following adjusting the layout parameter of the selected file;
based on determining that the first rule is violated following adjusting the layout parameter of the selected file, recursively adjusting layout parameters of the one or more next files until the first rule is satisfied; and
updating the presentation of the group of first files using the first template based on recursively adjusting the layout parameters of the one or more next files.

16. The non-transitory storage device of claim 15, wherein the instructions cause the one or more processors to perform operations further comprising:
receiving a second user input adding one or more new files to the group of first files for presentation on the graphical user interface; and
in response to receiving the second user input, adding the one or more new files to the group of first files, comprising:
for each file included in the one or more new files, adjusting the first template by performing the evaluating of a next file.

17. The non-transitory storage device of claim 15, wherein the instructions cause the one or more processors to perform operations further comprising:
presenting a group of second files on the graphical user interface using a second template, wherein presentation of the group of second files using the second template is controlled by a second rule associated with the second template, and wherein the group of second files is presented in conjunction with presenting the group of first files using the first template;
receiving, through the input interface, a second user input for adjusting a layout parameter of a selected file of the group of second files;
in response to receiving the second user input, adjusting the layout parameter of the selected file of the group of second files based on the second rule;
evaluating one or more next files in the group of second files to determine if the second rule is satisfied following adjusting the layout parameter of the selected file of the group of second files;
based on determining that the second rule is violated, recursively adjusting layout parameters of the one or more next files in the group of second files until the second rule is satisfied; and
updating the presentation of the group of second files using the second template based on recursively adjusting the layout parameters of the one or more next files in the group of second files.

18. A system comprising:
one or more processors; and
a storage device storing instructions that, when executed by the one or more processors, are configured to cause the one or more processors to perform operations comprising:
presenting a group of first files on a graphical user interface shown on a device display using a first template, wherein presentation of the group of first files on the graphical user interface using the first template is controlled by a first rule associated with the first template;
receiving, through an input interface, a first user input for adjusting a layout parameter of a selected file of the group of first files;
in response to receiving the first user input, examining the first rule associated with the first template, wherein the first rule constrains adjustment of the layout parameter of the selected file;
adjusting the layout parameter of the selected file based on the first rule;
evaluating one or more next files in the group of first files to determine if the first rule is satisfied following adjusting the layout parameter of the selected file;
based on determining that the first rule is violated following adjusting the layout parameter of the selected file, recursively adjusting layout parameters of the one or more next files until the first rule is satisfied; and
updating the presentation of the group of first files using the first template based on recursively adjusting the layout parameters of the one or more next files.

19. The system of claim 18, wherein the instructions cause the one or more processors to perform operations further comprising:
receiving a second user input adding one or more new files to the group of first files for presentation on the graphical user interface; and
in response to receiving the second user input, adding the one or more new files to the group of first files, comprising:
for each file included in the one or more new files, adjusting the first template by performing the evaluating of a next file.

20. The system of claim 18, wherein the instructions cause the one or more processors to perform operations further comprising:
presenting a group of second files on the graphical user interface using a second template, wherein presentation of the group of second files using the second template is controlled by a second rule associated with the second template, and wherein the group of second files is presented in conjunction with presenting the group of first files using the first template;
receiving, through the input interface, a second user input for adjusting a layout parameter of a selected file of the group of second files;
in response to receiving the second user input, adjusting the layout parameter of the selected file of the group of second files based on the second rule;
evaluating one or more next files in the group of second files to determine if the second rule is satisfied following adjusting the layout parameter of the selected file of the group of second files;
based on determining that the second rule is violated, recursively adjusting layout parameters of the one or more next files in the group of second files until the second rule is satisfied; and
updating the presentation of the group of second files using the second template based on recursively adjusting the layout parameters of the one or more next files in the group of second files.
